(19) United States
(12) Patent Application Publication
(10) Pub. No.: US 2025/0294563 A1
(43) Pub. Date: Sep. 18, 2025

(54) METHOD AND DEVICE FOR INCREASING UPLINK CONTROL RESOURCES IN WIRELESS COMMUNICATION SYSTEM

(71) Applicant: LG ELECTRONICS INC., Seoul (KR)

(72) Inventors: Seungjin AHN, Seoul (KR); Jaehyung KIM, Seoul (KR); Suckchel YANG, Seoul (KR); Youngdae LEE, Seoul (KR); Seokmin SHIN, Seoul (KR); Sunghoon LEE, Seoul (KR)

(73) Assignee: LG ELECTRONICS INC., Seoul (KR)

(21) Appl. No.: 18/861,141

(22) PCT Filed: Apr. 19, 2023
(86) PCT No.: PCT/KR2023/005277

§ 371 Date: Oct. 28, 2024

(30) Foreign Application Priority Data
Apr. 28, 2022 (KR) 10-2022-0053078
Apr. 28, 2022 (KR) 10-2022-0053079
Apr. 28, 2022 (KR) 10-2022-0053093

(51) Int. Cl. H04W 72/21; H04L 5/00

(52) U.S. Cl. CPC H04W 72/21; H04L 5/0005; H04L 5/0098

(57) ABSTRACT

The present disclosure relates to a method for operating a terminal in a wireless communication system, and the method may include receiving, by the terminal, an SSB, receiving system information based on the SSB from a base station, and performing uplink transmission by a PUCCH resource allocated through an index indicating a common PUCCH resource set included in the system information. Herein, based on the terminal being a first type terminal, uplink control information may be transmitted from the terminal to the base station through a PUCCH resource that is configured through the PUCCH resource set based on the index, and based on the terminal being a second type terminal, the uplink transmission may be performed through a resource that is distinguished by applying at least one of CDM, TDM and FDM to the PUCCH resource that is configured through the PUCCH resource set based on the index.

### CROSS-REFERENCE TO RELATED APPLICATION(S)

This application is the National Stage filing under 35 U.S.C. 371 of International Application No. PCT/KR2023/005277, filed on Apr. 19, 2023, which claims the benefit of earlier filing date and right of priority to Korean Application Nos. 10-2022-0053078, 10-2022-0053079 and 10-2022-0053093, all filed on Apr. 28, 2022, the contents of which are all incorporated by reference herein in their entirety.

### TECHNICAL FIELD

The present disclosure relates to a wireless communication system, and more particularly, to a method and apparatus for increasing an uplink control resource in a wireless communication system.

### BACKGROUND

Wireless communication systems have been widely deployed to provide various types of communication services such as voice or data. In general, a wireless communication system is a multiple access system that supports communication of multiple users by sharing available system resources (a bandwidth, transmission power, etc.). Examples of multiple access systems include a code division multiple access (CDMA) system, a frequency division multiple access (FDMA) system, a time division multiple access (TDMA) system, an orthogonal frequency division multiple access (OFDMA) system, and a single carrier frequency division multiple access (SC-FDMA) system.

In particular, as a large number of communication devices require a large communication capacity, the enhanced mobile broadband (eMBB) communication technology, as compared to the conventional radio access technology (RAT), is being proposed. In addition, not only massive machine type communications (massive MTC), which provide a variety of services anytime and anywhere by connecting multiple devices and objects, but also a communication system considering a service/user equipment (UE) sensitive to reliability and latency is being proposed. Various technical configurations for this are being proposed.

### SUMMARY

The present disclosure may provide a method and apparatus for increasing an uplink control resource in a wireless communication system.

The present disclosure may provide a method and apparatus for increasing an uplink control resource through a code division multiplexing (CDM) technique in a wireless communication system.

The present disclosure may provide a method and apparatus for increasing an uplink control resource through a time division multiplexing (TDM) technique in a wireless communication system.

The present disclosure may provide a method and apparatus for increasing an uplink control resource through a frequency division multiplexing (FDM) technique in a wireless communication system.

The present disclosure may provide a method and apparatus for determining a resource for a terminal using a 5 MHz band in a wireless communication system.

Technical objects to be achieved in the present disclosure are not limited to what is mentioned above, and other technical objects not mentioned therein can be considered from the embodiments of the present disclosure to be described below by those skilled in the art to which a technical configuration of the present disclosure is applied.

As an example of the present disclosure, a method of operating a terminal (user equipment, UE) in a wireless communication system may include receiving, by the terminal, a synchronization signal block (SSB), receiving system information based on the SSB from a base station, and performing uplink transmission on a physical uplink control channel (PUCCH) resource allocated by an index indicating a common PUCCH resource set included in the system information. Based on the terminal being a first type terminal, uplink control information may be transmitted from the terminal to the base station on a PUCCH resource that is configured by the PUCCH resource set based on the index, and based on the terminal being a second type terminal, the uplink transmission may be performed on a resource that is distinguished by applying at least one of code division multiplexing (CDM), time division multiplexing (TDM) and frequency division multiplexing (FDM) to the PUCCH resource that is configured by the PUCCH resource set based on the index.

In addition, as an example of the present disclosure, a method of operating a base station in a wireless communication system may include transmitting a synchronization signal block (SSB) to a terminal (user equipment, UE), transmitting system information based on the SSB to the terminal, and receiving uplink data by a physical uplink control channel (PUCCH) resource allocated by an index indicating a common PUCCH resource set included in the system information. Based on the terminal being a first type terminal, uplink control information may be transmitted from the terminal to the base station on a PUCCH resource that is configured by the PUCCH resource set based on the index, and based on the terminal being a second type terminal, the uplink transmission may be performed on a resource that is distinguished by applying at least one of code division multiplexing (CDM), time division multiplexing (TDM) and frequency division multiplexing (FDM) to the PUCCH resource that is configured by the PUCCH resource set based on the index.

In addition, as an example of the present disclosure, a terminal (user equipment, UE) in a wireless communication system may include a transceiver and a processor coupled with the transceiver, and the processor may control the transceiver to receive a synchronization signal block (SSB), to receive system information based on the SSB from a base station, and to perform uplink transmission on a physical uplink control channel (PUCCH) resource allocated by an index indicating a common PUCCH resource set included in the system information. Based on the terminal being a first type terminal, uplink control information may be transmitted from the terminal to the base station on a PUCCH resource that is configured by the PUCCH resource set based on the index, and based on the terminal being a second type terminal, the uplink transmission may be performed on a resource that is distinguished by applying at least one of code division multiplexing (CDM), time division multiplexing (TDM) and frequency division multiplexing (FDM) to the PUCCH resource that is configured by the PUCCH resource set based on the index.

In addition, as an example of the present disclosure, a base station in a wireless communication system may include a transceiver and a processor coupled with the transceiver, and the processor may control the transceiver to transmit a synchronization signal block (SSB) to a terminal, to transmit system information based on the SSB to the terminal, and to receive uplink data from the terminal by a physical uplink control channel (PUCCH) resource allocated by an index indicating a common PUCCH resource set included in the system information. Based on the terminal being a first type terminal, uplink control information may be transmitted from the terminal to the base station on a PUCCH resource that is configured by the PUCCH resource set based on the index, and based on the terminal being a second type terminal, the uplink transmission may be performed on a resource that is distinguished by applying at least one of code division multiplexing (CDM), time division multiplexing (TDM) and frequency division multiplexing (FDM) to the PUCCH resource that is configured by the PUCCH resource set based on the index.

In addition, as an example of the present disclosure, a communication device may include at least one processor and at least one computer memory coupled with the at least one processor and storing an instruction that instructs operations when executed by the at least one processor, and the operations may include receiving a synchronization signal block (SSB), receiving system information based on the SSB from a base station, and performing uplink transmission on a physical uplink control channel (PUCCH) resource allocated by an index indicating a common PUCCH resource set included in the system information. Based on the communication device being a first type communication device, uplink control information may be transmitted from the communication device to the base station on a PUCCH resource that is configured by the PUCCH resource set based on the index, and based on the communication device being a second type communication device, the uplink transmission may be performed on a resource that is distinguished by applying at least one of code division multiplexing (CDM), time division multiplexing (TDM) and frequency division multiplexing (FDM) to the PUCCH resource that is configured by the PUCCH resource set based on the index.

In addition, as an example of the present disclosure, a non-transitory computer-readable medium storing at least one instruction may include the at least one instruction that is executable by a processor, and the at least one instruction may control a device to receive a synchronization signal block (SSB), to receive system information based on the SSB from a base station, and to perform uplink transmission on a physical uplink control channel (PUCCH) resource allocated by an index indicating a common PUCCH resource set included in the system information. Based on the device being a first type device, uplink control information may be transmitted from a terminal to the base station on a PUCCH resource that is configured by the PUCCH resource set based on the index, and based on the device being a second type device, the uplink transmission may be performed on a resource that is distinguished by applying at least one of code division multiplexing (CDM), time division multiplexing (TDM) and frequency division multiplexing (FDM) to the PUCCH resource that is configured by the PUCCH resource set based on the index.

In addition, the following descriptions may commonly apply.

As an example of the present disclosure, a first type terminal may be a legacy terminal and be a terminal type that transmits uplink control information on a PUCCH resource, and a second type terminal may be a terminal using a 5 MHz band and be a terminal type that performs uplink transmission on a PUCCH resource.

In addition, as an example of the present disclosure, a second type terminal may perform uplink transmission by using a partial band of a frequency band that a first type terminal uses.

In addition, as an example of the present disclosure, a terminal may use a PUCCH resource allocated by an index as a common PUCCH resource before receiving a dedicated PUCCH configuration based on a connection to a base station.

In addition, as an example of the present disclosure, at least one of a PUCCH format, a start symbol of a PUCCH resource, the number of symbols of the PUCCH resource, a physical resource block (PRB) offset of the PUCCH resource, and a set of initial cyclic shift indexes may be configured based on a PUCCH resource set.

In addition, as an example of the present disclosure, based on CDM being applied to a PUCCH resource, an orthogonal cover code (OCC) may be applied to a resource, through which a second type terminal performs uplink transmission, and thus the resource may be distinguished from a PUCCH resource for a first type terminal.

In addition, as an example of the present disclosure, based on a first type PUCCH format being applied to a resource for performing uplink transmission based on an index, an OCC with a length of 2 may be applied to the resource for performing the uplink transmission.

In addition, as an example of the present disclosure, based on a second type PUCCH format being applied to a PUCCH resource based on an index, an OCC of the second type PUCCH format set by a dedicated PUCCH configuration may be applied to a resource for performing uplink transmission for a second type terminal.

In addition, as an example of the present disclosure, a PUCCH resource set may include 16 resources, 16 resources for a first type terminal may be determined based on the number of cyclic shifts and the number of PRBs, and 16 resources for a second type terminal may be determined based on the number of cyclic shifts, the number of OCCs, and the number of PRBs.

In addition, as an example of the present disclosure, an OCC index indicating an OCC applied to a second type terminal may be preset in the second type terminal or be indicated by a base station, and based on being indicated by the base station, the OCC index may be indicated to the second type terminal through higher layer signaling or be indicated in a random access procedure.

In addition, as an example of the present disclosure, based on TDM being applied to a PUCCH resource, a start symbol of a resource for performing uplink transmission for a second type terminal may be configured to be different from a start symbol of a PUCCH resource for a first type terminal so that the resource for performing the uplink transmission for the second type terminal and the PUCCH resource for the first type terminal may be distinguished.

In addition, as an example of the present disclosure, a base station may indicate at least one of a start symbol indication value and an offset value to a terminal, and based on the terminal receiving the start symbol indication value, the terminal may replace a start symbol of a PUCCH resource indicated by an index by the start symbol indication value, and based on the terminal receiving the offset value, the terminal may determine a symbol obtained by applying the offset value to the start symbol of the PUCCH resource indicated by the index as a start symbol of the PUCCH resource.

In addition, as an example of the present disclosure, at least one of a start symbol indication value and an offset value, which are applied to a second type terminal, may be preset in the second type terminal or be indicated by a base station, and based on being indicated by the base station, at least one of the start symbol indication value and the offset value may be indicated to the second type terminal through higher layer signaling or be indicated in a random access procedure.

In addition, as an example of the present disclosure, a PUCCH resource set may include 16 resources, 16 resources for a first type terminal may be determined based on the number of cyclic shifts and the number of PRBs, and 16 resources for a second type terminal may be determined based on the number of cyclic shifts, the number of start symbols, and the number of PRBs.

In addition, as an example of the present disclosure, based on FDM being applied to a PUCCH resource, an additional PRB offset other than a PRB offset may be applied to a resource for performing uplink transmission for a second type terminal so that the resource for performing the uplink transmission for the second type terminal and a PUCCH resource for the first type terminal may be distinguished.

In addition, as an example of the present disclosure, a base station may indicate at least one of an additional PRB offset value and an edge indicator to a terminal, and based on the terminal receiving only the PRB offset value, the terminal may apply the PRB offset value to a PRB offset of a PUCCH resource indicated by an index, and based on the terminal receiving the PRB offset value and the edge indicator, the terminal may apply an offset value to the PRB offset of the PUCCH resource indicated by the index based on a boundary indicated by the edge indicator.

The above-described aspects of the present disclosure are merely a part of exemplary embodiments of the present disclosure, and various embodiments reflecting technical features of the present disclosure may be derived and understood by those skilled in the art based on the detailed description of the present disclosure below.

As is apparent from the above description, the embodiments of the present disclosure have the following effects.

According to the present disclosure, it is possible to increase an uplink control resource in a wireless communication system.

According to the present disclosure, it is possible to increase an uplink control resource through a CDM technique in a wireless communication system.

According to the present disclosure, it is possible to increase an uplink control resource through a TDM technique in a wireless communication system.

According to the present disclosure, it is possible to increase an uplink control resource through a FDM technique in a wireless communication system

It will be appreciated by persons skilled in the art that that the effects that can be achieved through the embodiments of the present disclosure are not limited to those described above and other advantageous effects of the present disclosure will be more clearly understood from the following detailed description. That is, unintended effects according to implementation of the present disclosure may be derived by those skilled in the art from the embodiments of the present disclosure.

### BRIEF DESCRIPTION OF THE DRAWINGS

The accompanying drawings, which are incorporated as part of the detailed description to facilitate an understanding of the present disclosure, provide embodiments of the present disclosure and, together with the detailed description, illustrate technical features of the present disclosure.

FIG. 1 illustrates an example of a structure of a wireless communication system to which the present disclosure may be applied.

FIG. 2 illustrates an example of a wireless device applicable to the present disclosure.

FIG. 3 illustrates a frame structure in a wireless communication system to which the present disclosure may be applied.

FIG. 4 illustrates an example of a resource grid in a wireless communication system to which the present disclosure may be applied.

FIG. 5 illustrates an example of a physical resource block in a wireless communication system to which the present disclosure may be applied.

FIG. 6 illustrates an example of a slot structure in a wireless communication system to which the present disclosure may be applied.

FIG. 7 illustrates examples of physical channels used in a wireless communication system, to which the present disclosure may be applied, and an example of a general signal transmission and reception method using the physical channels.

FIG. 8 is a view showing an initial start position of a CS index based on an index for a PUCCH resource set used in a wireless communication system to which the present disclosure is applicable.

FIG. 9 is a view showing a method for applying an OCC to a PUCCH format 1 used in a wireless communication system to which the present disclosure is applicable.

FIG. 10 is a view showing a method for allocating a PRB of a PUCCH resource used in a wireless communication system to which the present disclosure is applicable.

FIG. 11 is a view showing a method for allocating a PRB of a PUCCH resource used in a wireless communication system to which the present disclosure is applicable.

FIG. 12 is a view showing a method for indicating information for an e-redcap terminal used in a wireless communication system to which the present disclosure is applicable.

FIG. 13 is a view showing a method for indicating an OCC index used in a wireless communication system to which the present disclosure is applicable.

FIG. 14 is a view showing a method for determining a start symbol position differently according to a terminal type in a wireless communication system to which the present disclosure is applicable.

FIG. 15 is a view showing a method for allocating a PRB of a PUCCH resource used in a wireless communication system to which the present disclosure is applicable.

FIG. 16 is a view showing a method for allocating a PRB of a PUCCH resource used in a wireless communication system to which the present disclosure is applicable.

FIG. 17 is a view showing a method for allocating a PUCCH resource used in a wireless communication system to which the present disclosure is applicable.

FIG. 18 is a view showing a method for allocating a PUCCH resource used in a wireless communication system to which the present disclosure is applicable.

FIG. 19 is a view showing a method for allocating a PUCCH resource used in a wireless communication system to which the present disclosure is applicable.

FIG. 20 is a view showing a method for allocating a PUCCH resource used in a wireless communication system to which the present disclosure is applicable.

FIG. 21 is a view showing a method for allocating a PUCCH resource used in a wireless communication system to which the present disclosure is applicable.

FIG. 22 is a view showing a method for allocating a PUCCH resource used in a wireless communication system to which the present disclosure is applicable.

FIG. 23 is a view showing a method for allocating a PUCCH resource used in a wireless communication system to which the present disclosure is applicable.

FIG. 24 is a view showing a method for allocating a PUCCH resource used in a wireless communication system to which the present disclosure is applicable.

FIG. 25 is a flowchart showing a method of operating a terminal that is applicable to the present disclosure.

FIG. 26 is a flowchart showing a method of operating a base station that is applicable to the present disclosure.

### DETAILED DESCRIPTION

The embodiments of the present disclosure described below are combinations of elements and features of the present disclosure in specific forms. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions or elements of any one embodiment may be included in another embodiment and may be replaced with corresponding constructions or features of another embodiment.

In the description of the drawings, procedures or steps which render the scope of the present disclosure unnecessarily ambiguous will be omitted and procedures or steps which can be understood by those skilled in the art will be omitted.

Throughout the specification, when a certain portion “includes” or “comprises” a certain component, this indicates that other components are not excluded and may be further included unless otherwise noted. The terms “unit”, “-or/er” and “module” described in the specification indicate a unit for processing at least one function or operation, which may be implemented by hardware, software or a combination thereof. In addition, the terms “a or an”, “one”, “the” etc. may include a singular representation and a plural representation in the context of the present disclosure (more particularly, in the context of the following claims) unless indicated otherwise in the specification or unless context clearly indicates otherwise.

In the embodiments of the present disclosure, a description is mainly made of a data transmission and reception relationship between a base station (BS) and a mobile station. A BS refers to a terminal node of a network, which directly communicates with a mobile station. A specific operation described as being performed by the BS may be performed by an upper node of the BS.

Namely, it is apparent that, in a network comprised of a plurality of network nodes including a BS, various operations performed for communication with a mobile station may be performed by the BS, or network nodes other than the BS. The term “BS” may be replaced with a fixed station, a Node B, an evolved Node B (eNode B or eNB), an advanced base station (ABS), an access point, etc.

In the embodiments of the present disclosure, the term terminal may be replaced with a UE, a mobile station (MS), a subscriber station (SS), a mobile subscriber station (MSS), a mobile terminal, an advanced mobile station (AMS), etc.

A transmitter is a fixed and/or mobile node that provides a data service or a voice service and a receiver is a fixed and/or mobile node that receives a data service or a voice service. Therefore, a mobile station may serve as a transmitter and a BS may serve as a receiver, on an uplink (UL). Likewise, the mobile station may serve as a receiver and the BS may serve as a transmitter, on a downlink (DL).

The embodiments of the present disclosure may be supported by standard specifications disclosed for at least one of wireless access systems including an Institute of Electrical and Electronics Engineers (IEEE) 802.xx system, a 3rd Generation Partnership Project (3GPP) system, a 3GPP Long Term Evolution (LTE) system, 3GPP 5th generation (5G) new radio (NR) system, and a 3GPP2 system. In particular, the embodiments of the present disclosure may be supported by the standard specifications, 3GPP TS 36.211, 3GPP TS 36.212, 3GPP TS 36.213, 3GPP TS 36.321 and 3GPP TS 36.331.

In addition, the embodiments of the present disclosure are applicable to other radio access systems and are not limited to the above-described system. For example, the embodiments of the present disclosure are applicable to systems applied after a 3GPP 5G NR system and are not limited to a specific system.

That is, steps or parts that are not described to clarify the technical features of the present disclosure may be supported by those documents. Further, all terms as set forth herein may be explained by the standard documents.

Reference will now be made in detail to the embodiments of the present disclosure with reference to the accompanying drawings. The detailed description, which will be given below with reference to the accompanying drawings, is intended to explain exemplary embodiments of the present disclosure, rather than to show the only embodiments that can be implemented according to the disclosure.

The following detailed description includes specific terms in order to provide a thorough understanding of the present disclosure. However, it will be apparent to those skilled in the art that the specific terms may be replaced with other terms without departing the technical spirit and scope of the present disclosure.

The embodiments of the present disclosure can be applied to various radio access systems such as code division multiple access (CDMA), frequency division multiple access (FDMA), time division multiple access (TDMA), orthogonal frequency division multiple access (OFDMA), single carrier frequency division multiple access (SC-FDMA), etc.

Hereinafter, in order to clarify the following description, a description is made based on a 3GPP communication system (e.g., LTE, NR, etc.), but the technical spirit of the present disclosure is not limited thereto. LTE may refer to technology after 3GPP TS 36.xxx Release 8. In detail, LTE technology after 3GPP TS 36.xxx Release 10 may be referred to as LTE-A, and LTE technology after 3GPP TS 36.xxx Release 13 may be referred to as LTE-A pro. 3GPP NR may refer to technology after TS 38.xxx Release 15. 3GPP 6G may refer to technology TS Release 17 and/or Release 18. “xxx” may refer to a detailed number of a standard document. LTE/NR/6G may be collectively referred to as a 3GPP system.

3GPP 6G may mean a post-3GPP NR technology based on a 3GPP system. 3GPP 6G may not limited to a Release or a specific TS document, and its name may have a different form from 3GPP 6G. That is, 3GPP 6G may mean a technology introduced after 3GPP NR and is not limited to a specific form.

The description below will mainly focus on a 3GPP NR system but is not limited thereto and may be applied to 3GPP 6G. Furthermore, what is described below may be partially modified to be used in consideration of a 3GPP 6G system and is not limited to a specific form. However, hereinafter, for convenience of explanation, the 3GPP NR system will be mainly described. For background arts, terms, abbreviations, etc. used in the present disclosure, refer to matters described in the standard documents published prior to the present disclosure. For example, reference may be made to the standard documents 36.xxx and 38.xxx.

### Overall System

As more communication devices require larger communication capacities, the need for mobile broadband communication more enhanced than the existing Radio Access Technology (RAT) is on the rise. In addition, massive machine type communication (MTC), which provides a variety of services anytime and anywhere by connecting a plurality of devices and things, is also one of main issues worthy of consideration in next-generation communication. Furthermore, a communication system design considering a service/a terminal sensitive to reliability and latency is also under discussion. Thus, introduction of a next-generation RAT considering enhanced mobile broadband communication (eMBB), massive MTC (mMTC), ultra-reliable and low latency communication (URLLC) and the like is under discussion, and for convenience, a corresponding technology is referred to as NR in the present disclosure. NR is an expression which represents an example of a 5G RAT.

A new RAT system including NR uses an OFDM transmission method or a similar transmission method. The new RAT system may follow OFDM parameters different from OFDM parameters of LTE. Alternatively, the new RAT system may follow a numerology of the existing LTE/LTE-A as it is but support a wider system bandwidth (e.g., 100 MHz). Alternatively, one cell may support a plurality of numerologies. In other words, terminals which operate in accordance with different numerologies may coexist in one cell.

A numerology corresponds to one subcarrier spacing in a frequency domain. As a reference subcarrier spacing is scaled by an integer N, a different numerology may be defined.

In addition, a new RAT system including 6G may be considered as a next-generation RAT. The new RAT system including 6G may consider i) very high data speed per device, ii) a large number of connected devices, iii) global connectivity, iv) very low latency, v) reduction of energy consumption of battery-free IoT devices, vi) ultra-high reliability connection, and vii) a connected intelligence with machine learning ability, but is not limited thereto. The new RAT system including 6G may consider using a terahertz (THz) frequency band, that is, a frequency higher than an NR system, for a wider bandwidth and a higher transmission speed in consideration of what is described above. The RAT system including 6G may overcome an existing limitation by applying artificial intelligence/machine learning (AI/ML), but may not be limited thereto.

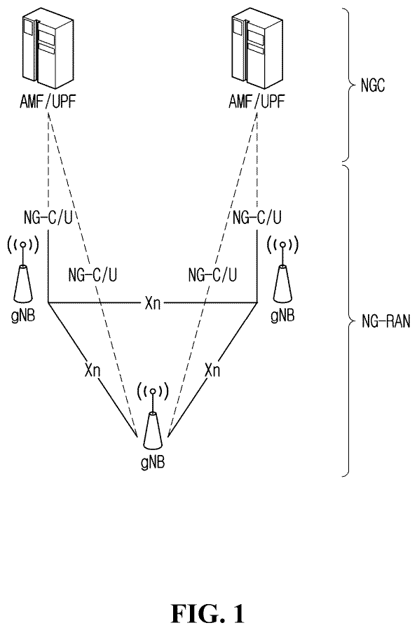

FIG. 1 exemplifies a structure of a wireless communication system to which the present disclosure may be applied. Referring to FIG. 1, NG-RAN consists of gNBs that provide control plane (RRC) protocol terminations for a NG-Radio Access (NG-RA) user plane (that is, a new access stratum (AS) sublayer/packet data convergence protocol (PDCP)/radio link control (RLC)/MAC/PHY) and a UE. The gNBs are interconnected through a Xn interface. In addition, the gNBs are connected to a new generation core (NGC) through an N2 interface. More specifically, the gNBs are connected to a access and mobility management function (AMF) through an N2 interface and are connected to a user plane function (UPF) through an N3 interface. FIG. 1 may be a structure based on an NR system, the structure of FIG. 1 may be used in a 6G system either as it is or by being partially modified and is not limited to a specific form.

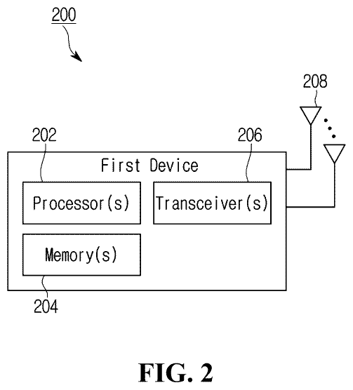

FIG. 2 illustrates an example of a wireless device applicable to the present disclosure.

Referring to FIG. 2, a wireless device 200 may transmit/receive a radio signal through various wireless access technologies (e.g., LTE, LTE-A, LTE-A pro, NR, 5G, 5G-A, 6G). The wireless device 200 may include at least one processor 202 and at least one memory 204 and additionally further include at least one transceiver 206 and/or at least one antenna 208.

The processor 202 may be configured to control the memory 204 and/or the transceiver 206 and to implement the descriptions, functions, procedures, proposals, methods, and/or operation flowcharts disclosed in this document. For example, the processor 202 may generate first information/signal by processing information in the memory 204 and then transmit a radio signal including the first information/signal through the transceiver 206. In addition, the processor 202 may receive a radio signal including second information/signal through the transceiver 206 and then store information obtained from signal processing of the second information/signal in the memory 204. The memory 204 may be connected to the processor 202 and store a variety of information associated with an operation of the processor 202. For example, the memory 204 may store a software code including instructions for implementing some or all of processes controlled by the processor 202 or for implementing the descriptions, functions, procedures, proposals, methods, and/or operation flowcharts disclosed in this document. Herein, the processor 202 and the memory 204 may be a part of a communication modem/circuit/chip designed for implementing a wireless communication technology. The transceiver 206 may be connected to the processor 202 and transmit and/or receive a radio signal through the at least one antenna 208. The transceiver 206 may be a transmitter and/or a receiver. The transceiver 206 may be used interchangeably with a radio frequency (RF) unit. In the present disclosure, a wireless device may mean a communication modem/circuit/chip.

Hereinafter, a hardware element of the wireless device 200 will be described in further detail. Although not being limited thereto, at least one protocol layer may be implemented by the at least one processor 202. For example, the at least one processor 202 may implement at least one layer (e.g., a functional layer such as physical (PHY), media access control (MAC), radio link control (RLC), packet data convergence protocol (PDCP), radio resource control (RRC), and service data adaptation protocol (SDAP)). The at least one processor 202 may generate at least one protocol data unit (PDU) and/or at least one service data unit (SDU) according to the descriptions, functions, procedures, proposals, methods, and/or operation flowcharts disclosed in this document. The at least one processor 202 may generate a message, control information, data, or information according to the descriptions, functions, procedures, proposals, methods, and/or operation flowcharts disclosed in this document. The at least one processor 202 may generate a signal (e.g., a baseband signal) including a PDU, an SDU, a message, control information, data, or information according to a function, a procedure, a suggestion and/or a method, which are disclosed in the present document, and provide the signal to the at least one transceiver 206. The at least one processor 202 may receive a signal (e.g., a baseband signal) from the at least one transceiver 206 and obtain a PDU, an SDU, a message, control information, data, or information according to the descriptions, functions, procedures, proposals, methods, and/or operation flowcharts disclosed in this document.

The at least one processor 202 may be referred to as a controller, a microcontroller, a microprocessor, or a microcomputer. The at least one processor 202 may be implemented by hardware, firmware, software, or a combination thereof. As an example, at least one application specific integrated circuit (ASIC), at least one digital signal processor (DSP), at least one digital signal processing devices (DSPD), at least one programmable logic device (PLD), or at least one field programmable gate array (FPGA) may be included in the at least one processor 202. The descriptions, functions, procedures, proposals, methods, and/or operation flowcharts disclosed in this document may be implemented using firmware or software, and the firmware or software may be implemented to include the modules, procedures, or functions. Firmware or software configured to perform the descriptions, functions, procedures, proposals, methods, and/or operation flowcharts disclosed in this document may be included in the at least one processor 202 or may be stored in the at least one memory 204 and executed by the at least one processor 202. The descriptions, functions, procedures, proposals, methods, and/or operation flowcharts disclosed in this document may be implemented using firmware or software in the form of code, an instruction, and/or a set of instructions.

The at least one memory 204 may be connected to the at least one processor 202 and store various forms of data, signals, messages, information, programs, codes, indications, and/or instructions. The at least one memory 204 may be configured as a read only memory (ROM), a random access memory (RAM), an erasable programmable read only memory (EPROM), a flash memory, a hard drive, a register, a cache memory, a computer-readable storage media, and/or a combination thereof. The at least one memory 204 may be located at the interior and/or exterior of the at least one processor 202. In addition, the at least one memory 204 may be connected to the at least one processor 202 through various technologies such as wired or wireless connection.

The at least one transceiver 206 may transmit user data, control information, and wireless signals/channels, mentioned in the methods and/or operation flowcharts of this document, to at least one other device. The at least one transceiver 206 may receive user data, control information, and wireless signals/channels, mentioned in the descriptions, functions, procedures, proposals, methods, and/or operation flowcharts disclosed in this document, from at least one other device. For example, the at least one transceiver 206 may be connected to the at least one processor 202 and transmit and receive radio signals. For example, the at least one processor 202 may control the at least one transceiver 206 to transmit user data, control information, or a radio signal to at least one other device. In addition, the at least one processor 202 may control the at least one transceiver 206 to receive user data, control information, or a radio signal from at least one other device. In addition, the at least one transceiver 206 may be connected to the at least one antenna 208, and the at least one transceiver 206 may be configured to transmit and receive user data, control information, radio signals/channels mentioned in the descriptions, functions, procedures, proposals, methods and/or operation flowcharts disclosed in this document through the at least one antenna 208. In this document, the at least one antenna may be a plurality of physical antennas or a plurality of logical antennas (e.g., antenna ports). The at least one transceiver 206 may convert received radio signals/channels from RF band signals into baseband signals in order to process received user data, control information, and radio signals/channels using the at least one processor 202. The at least one transceiver 206 may convert the user data, control information, and radio signals/channels processed using the at least one processor 202 from the baseband signals into the RF band signals. To this end, the at least one transceiver 206 may include an (analog) oscillator and/or a filter.

The constituents of the wireless device, which are described in reference to FIG. 2, may be referred to as other terms from functional aspects. For example, the processor 202 may be referred to as a control unit, the transceiver 206 may be referred to as a communication unit, and the memory 204 may be referred to as a storage unit. In some cases, the communication unit may be used for a meaning including at least a part of the processor 202 and the transceiver 206.

The structure of the wireless device, which is described in reference to FIG. 2, may be understood as a structure of at least a part of various devices. As an example, the structure may be at least a part of various devices (e.g., a robot, a vehicle, an XR device, a hand-held device, a home appliance, an IoT device, an AI device/a server, etc.). Furthermore, according to various embodiments, apart from the constituents exemplified in FIG. 2, a device may further other constituents.

For example, a device may be a hand-held device such as a smartphone, a smart pad, a wearable device (e.g., a smart watch, smart glasses), and a hand-held computer (e.g., a laptop, etc.). In this case, the device may further include at least one of a power supply unit that supplies power and includes a wired/wireless charging circuit, a battery and the like, an interface unit including at least one port (e.g., an audio input/output port, a video input/output port) for connection to another device, and an input/output unit for inputting and outputting video information/signals, audio information/signals, data and/or information input from a user.

For example, a device may be a mobile device such as a mobile robot, a vehicle, a train, a manned/unmanned aerial vehicle (AV), and a ship. In this case, the device may further include at least one of a drive unit including at least one of the engine, motor, powertrain, wheels, brake, and steering device of the device, a power supply unit that supplies power and includes a wired/wireless charging circuit, a battery and the like, a sensor unit that senses state information of the device or surrounding the device, environment information and user information, an autonomous driving unit that performs functions such as route maintenance, speed control and destination setting, and a location measurement unit that obtains moving object location information through a global positioning system (GPS) and various sensors.

For example, a device may be an XR device such as an HMD, a head-up display (HUD) provided in a vehicle, a television, a smartphone, a wearable device, a home appliance device, a digital signage, a vehicle, and a robot. In this case, the device may further include at least one of a power supply unit that supplies power and includes a wired/wireless charging circuit, a battery and the like, an input/output unit that obtains control information and data from outside and outputs a generated XR object, and a sensor unit that senses state information of the device or surrounding the device, environment information and user information.

For example, a device may be a robot that may be classified for industrial use, medical use, domestic use, military use and the like according to purposes of use or fields. In this case, the device may further include at least one of a sensor unit that senses state information of the device or surrounding the device, environment information and user information and a drive unit that moves robot joints and performs various other physical operations.

For example, a device may be an AI device such as a TV, a projector, a smartphone, a PC, a laptop, a terminal for digital broadcasting, a tablet PC, a wearable device, a set-top box (STB), a radio, a washing machine, a refrigerator, a digital signage, a robot, and a vehicle. In this case, the device may further include at least one of an input unit that obtains various types of data from outside, an output unit that generates outputs associated with sight, hearing, or touch, a sensor unit that senses state information of the device or surrounding the device, environment information and user information, and a training unit that uses learning data to learn a model consisting of artificial neural networks. The structure of the wireless device exemplified in FIG. 2 may be understood as a part of a RAN node (e.g., a base station, a DU, a RU, a RRH, etc.). That is, the device exemplified in FIG. 2 may be a RAN node. In this case, the device may further include a wired transceiver for front haul and/or back haul communication. However, in case the front haul and/or back haul communication is based on wireless communication, the at least one transceiver 206 exemplified in FIG. 2 may be used for the front haul and/or back haul communication, and no wired transceiver may be included.

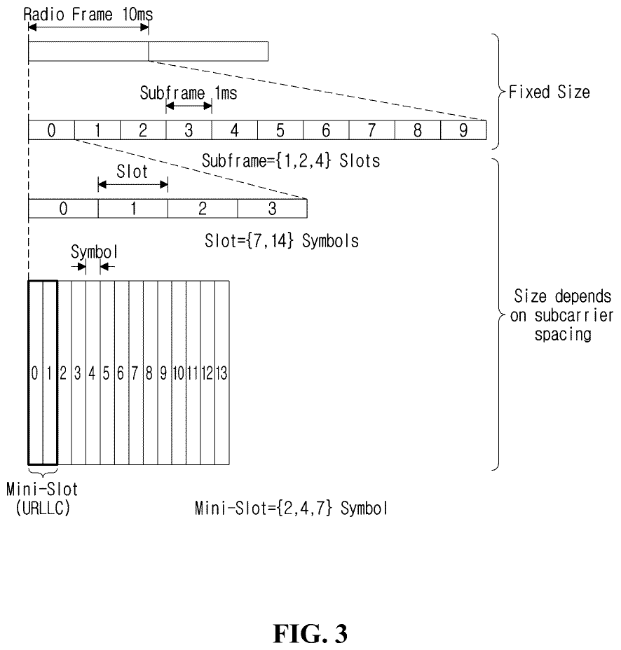

FIG. 3 exemplifies a frame structure in a wireless communication system to which the present disclosure may be applied.

A NR system may support a plurality of numerologies. Here, a numerology may be defined by a subcarrier spacing and a cyclic prefix (CP) overhead. Here, a plurality of subcarrier spacings may be derived by scaling a default (reference) subcarrier spacing by an integer N (or u). In addition, although it is assumed that a very low subcarrier spacing is not used in a very high carrier frequency, a numerology used herein may be selected independently from a frequency band. In addition, a variety of frame structures according to a plurality of numerologies may be supported in a NR system.

Hereinafter, an OFDM numerology and frame structure which may be considered in a NR system will be described. A plurality of OFDM numerologies supported in a NR system may be defined as in the following Table 1.

TABLE 1

| μ | Δf = 2^{μ} · 15[kHz] | CP |
|---|---|---|
| 0 | 15 | Normal |
| 1 | 30 | Normal |
| 2 | 60 | Normal, Extended |
| 3 | 120 | Normal |
| 4 | 240 | Normal |

NR supports a plurality of numerologies (or subcarrier spacings (SCS)) for supporting a variety of 5G services. For example, when a SCS is 15 kHz, a wide area in traditional cellular bands is supported, and when a SCS is 30 kHz/60 kHz, a dense-urban area, lower latency and a wider carrier bandwidth are supported, and when a SCS is 60 kHz or higher, a bandwidth wider than 24.25 GHz is supported to overcome a phase noise.

An NR frequency band is defined as a frequency range in two types (FR1, FR2). FR1 and FR2 may be configured as in the following Table 2. In addition, FR2 may mean a millimeter wave (mmW).

TABLE 2

| Frequency Range | | Subcarrier | |
|---|---|---|---|
| designation | Corresponding frequency range | spacing | |
| FR1 | 410 MHz-7125 MHz | 15, 30, 60 | kHz |
| FR2 | 24250 MHz-52600 MHz | 60, 120, 240 | kHz |

Regarding a frame structure in an NR system, sizes of various fields in a time domain are expressed as multiples of a time unit of T_{c}=1/(Δfₘₐₓ·N_{f}). Here, Δfₘₐₓ is 480·10³ Hz and N_{f} is 4096. Downlink and uplink transmission is configured (organized) with a radio frame having a duration of T_{f}=1/(Δfₘₐₓ·N_{f}/100)T_{c}=10 ms. Here, the radio frame is configured with 10 subframes having a duration of T_{sf}=(Δfₘₐₓ·N_{f}/1000) T_{c}=1 ms, respectively. In this case, there may be one set of frames for an uplink and one set of frames for a downlink. In addition, transmission in an uplink frame No. i from a terminal should start earlier by T_{TA}=(N_{TA}+N_{TA,offset})T_{c} than a corresponding downlink frame in a corresponding terminal starts. For a subcarrier spacing configuration u, slots are numbered in slot an increasing order of nₛ_{_{∈}}^{μ}{0, . . . , Nₛₗₒₜ^{subframe,μ}−1} in a subframe and are numbered in an increasing order of n_{sf}_{_{∈}}^{μ}{0, . . . , Nₛₗₒₜ^{frame,μ}−1} in a radio frame. One slot is configured with N_{symb}^{slot} consecutive OFDM symbols and N_{symb}^{slot} is determined according to CP. A start of a slot nₛ^{μ} in a subframe is temporally arranged with a start of an OFDM symbol nₛ^{μ}N_{symb}^{slot} in the same subframe. All terminals may not perform transmission and reception at the same time, which means that not all OFDM symbols of a downlink slot or an uplink slot are available.

Table 3 represents the number of OFDM symbols per slot (N_{symb}^{slot}), the number of slots per radio frame (Nₛₗₒₜ^{frame,μ}) and the number of slots per subframe (Nₛₗₒₜ^{subframe,μ}) in a normal CP and Table 4 represents the number of OFDM symbols per slot, the number of slots per radio frame and the number of slots per subframe in an extended CP.

TABLE 3

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

TABLE 4

| μ | N_{symb}^{slot} | Nₛₗₒₜ^{frame, μ} | Nₛₗₒₜ^{subframe, μ} |
|---|---|---|---|
| 2 | 12 | 40 | 4 |

FIG. 3 is an example on μ=2 (SCS is 60 kHz), and referring to Table 3, 1 subframe may include 4 slots. 1 subframe={1,2,4} slot shown in FIG. 3 is an example, and the number of slots which may be included in 1 subframe is defined as in Table 3 or Table 4. In addition, a mini-slot may include 2, 4 or 7 symbols or more or less symbols.

Regarding a physical resource in a NR system, an antenna port, a resource grid, a resource element, a resource block, a carrier part and the like may be considered. Hereinafter, the physical resources which may be considered in an NR system will be described in detail.

First, in relation to an antenna port, an antenna port is defined so that a channel where a symbol in an antenna port is carried can be inferred from a channel where another symbol in the same antenna port is carried. When a large-scale property of a channel where a symbol in one antenna port is carried may be inferred from a channel where a symbol in another antenna port is carried, it may be said that the two antenna ports are in a quasi co-located or quasi co-location (QC/QCL) relationship. In this case, the large-scale property includes one or more of delay spread, doppler spread, frequency shift, average received power, and received timing.

In a 6G system, communication may be performed at the above-described THz band that is higher than millimeter wave (mmW) frequency, and the same frame structure as shown in FIG. 3 may be used or a separate frame structure for the 6G system may be used but is not limited to a specific form.

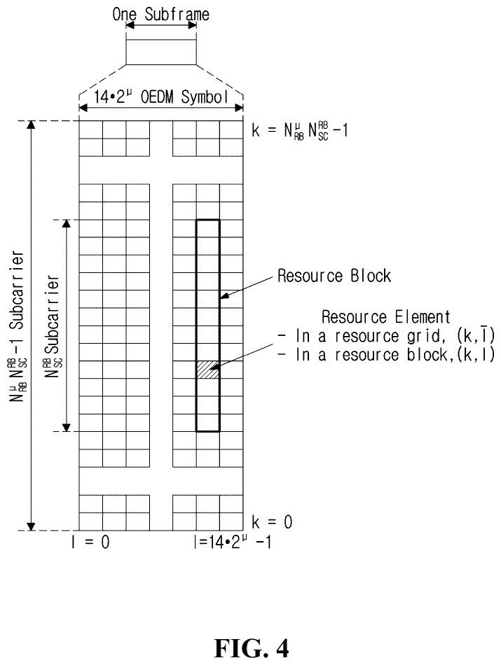

FIG. 4 exemplifies a resource grid in a wireless communication system to which the present disclosure may be applied.

Referring to FIG. 4, as an illustrative description, a resource grid is configured with N_{RB}^{μ}N_{SC}^{RB} subcarriers in a frequency domain, and one subframe is configured with 14·2^{μ} OFDM symbols, but the resource grid and the subframe are not limited thereto.

In an NR system, a transmitted signal is described by one or more resource grids configured with 2^{μ}N_{symb}^{(μ)} OFDM symbols and N_{RB}^{μ}N_{SC}^{RB} subcarriers. Here, N_{RB}^{μ}≤N_{RB}^{max,μ}. The N_{RB}^{max,μ} represents a maximum transmission bandwidth, which may be different between an uplink and a downlink as well as between numerologies. In this case, one resource grid may be configured per u and antenna port p. Each element of a resource grid for u and an antenna port p is referred to as a resource element and is uniquely identified by an index pair (k, l′). Here, k=0, . . . , N_{RB}^{μ}N_{SC}^{RB}−1 is an index in a frequency domain and l′=0, . . . , 2^{μ}N_{symb}^{(μ)}−1 refers to a position of a symbol in a subframe. When referring to a resource element in a slot, an index pair (k, l) is used. Here, 1=0, . . . , 2^{μ}N_{symb}^{(μ)}−1. A resource element (k, l′) for μ and an antenna port p corresponds to a complex value, a_{k,f}^{(p,μ)}. When there is no risk of confusion or when a specific antenna port or numerology is not specified, indexes p and μ may be dropped, whereupon a complex value may be a_{k,l′}^{(p)} or a_{k,l′}. In addition, a resource block (RB) is defined as N_{sc}^{RB}=12 consecutive subcarriers in a frequency domain.

Point A plays a role as a common reference point of a resource block grid and is obtained as follows.
offsetToPointA for a primary cell (PCell) downlink represents a frequency offset between point A and a lowest subcarrier of a lowest resource block overlapping with a SS/PBCH block which is used by a terminal for initial cell selection. It is expressed in resource block units assuming a 15 kHz subcarrier spacing for FR1 and a 60 kHz subcarrier spacing for FR2.
absoluteFrequencyPointA represents a frequency-position of point A expressed as in an absolute radio-frequency channel number (ARFCN).

Common resource blocks are numbered from 0 to the top in a frequency domain for a subcarrier spacing configuration u. The center of subcarrier 0 of common resource block 0 for a subcarrier spacing configuration u is identical to ‘point A’. A relationship between a common resource block number n_{CRB}^{μ} and a resource element (k, l) for a subcarrier spacing configuration u in a frequency domain is given as in the following Equation 1.

$${n}_{CRB}^{μ} = ⌊ \frac{k}{{N}_{sc}^{RB}} ⌋ \qquad [ Equation 1 ]$$

In Equation 1, k is defined relatively to point A so that k=0 corresponds to a subcarrier size, u centering around point A. Physical resource blocks are numbered from 0 to N_{BWP,i}^{size,μ}−1 in a bandwidth part (BWP) and i is the number of a BWP. A relationship between a physical resource block n_{PRB} and a common resource block n_{CRB} in BWP i is given by the following Equation 2.

$${n}_{CRB}^{μ} = {n}_{PRB}^{μ} + {N}_{BWP , i}^{start , μ} \qquad [ Equation 2 ]$$

N_{BWP,i}^{start,μ} is a common resource block that a BWP starts relatively to common resource block 0.

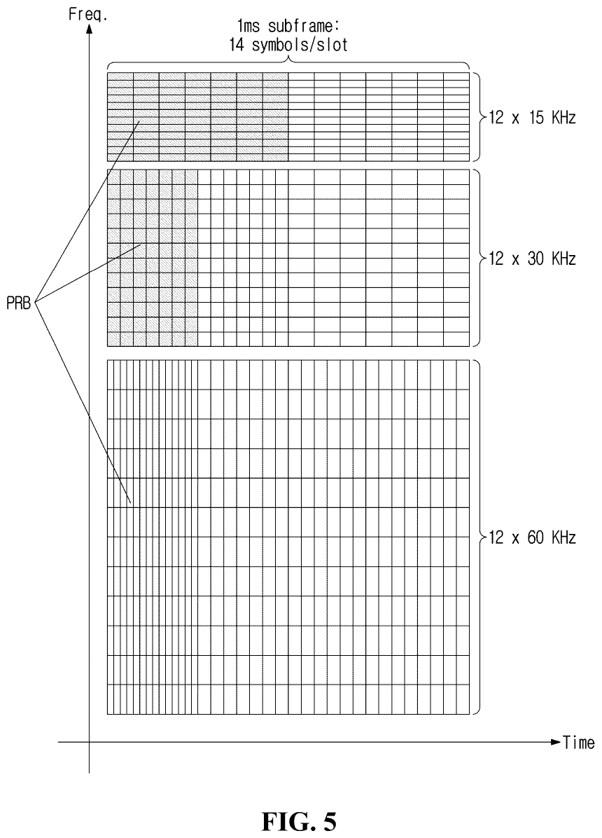

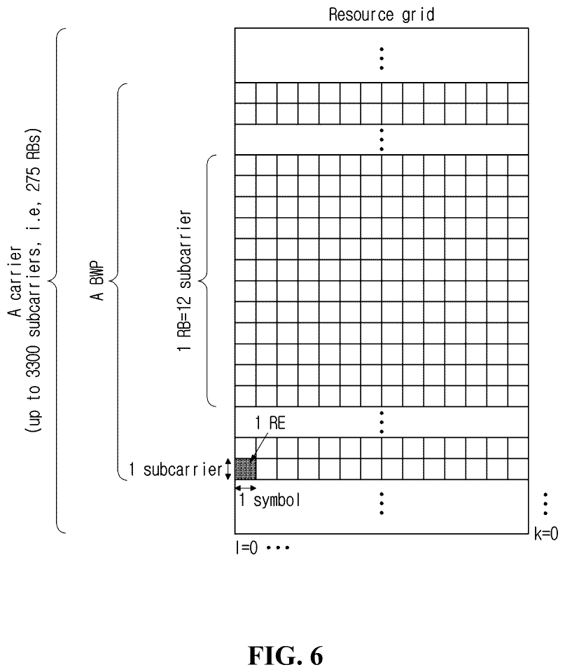

FIG. 5 exemplifies a physical resource block in a wireless communication system to which the present disclosure may be applied. In addition, FIG. 6 exemplifies a slot structure in a wireless communication system to which the present disclosure may be applied.

Referring to FIG. 5 and FIG. 6, a slot includes a plurality of symbols in a time domain. For example, for a normal CP, one slot includes 7 symbols, but for an extended CP, one slot includes 6 symbols.

A carrier includes a plurality of subcarriers in a frequency domain. A resource block (RB) is defined as a plurality of (e.g., 12) consecutive subcarriers in a frequency domain. A bandwidth part (BWP) is defined as a plurality of consecutive (physical) resource blocks in a frequency domain and may correspond to one numerology (e.g., an SCS, a CP length, etc.). A carrier may include a maximum of N (e.g., 5) BWPs. Data communication may be performed through an activated BWP and only one BWP may be activated for one terminal. In a resource grid, each element is referred to as a resource element (RE) and one complex symbol may be mapped.

In an NR system, up to 400 MHz may be supported per component carrier (CC). In case a terminal operating in such a wideband CC always operates with a radio frequency (FR) chip for the whole CC being turned on, terminal battery consumption may increase. Alternatively, when several application cases operating in one wideband CC (e.g., eMBB, URLLC, Mmtc, V2X, etc.) are considered, a different numerology (e.g., a subcarrier spacing, etc.) may be supported per frequency band in a corresponding CC. Alternatively, each terminal may have a different capability for the maximum bandwidth. In this regard, a base station may instruct a terminal to operate only in a partial bandwidth, not in an overall bandwidth of a wideband CC, and a corresponding partial bandwidth is defined as a bandwidth part (BWP) for convenience. A BWP may be configured with consecutive RBs on a frequency axis and may correspond to one numerology (e.g., a subcarrier spacing, a CP length, a slot/a mini-slot duration).

Meanwhile, a base station may configure a plurality of BWPs even in one CC configured for a terminal. For example, a BWP occupying a relatively small frequency domain may be configured in a PDCCH monitoring slot, and a PDSCH indicated by a PDCCH may be scheduled in a greater BWP. Alternatively, when UEs are congested in a specific BWP, some terminals may be configured with another BWP for load balancing. Alternatively, considering frequency domain inter-cell interference cancellation between neighboring cells and the like, some middle spectrums of a whole bandwidth may be excluded and BWPs on both edges may be configured in the same slot. In other words, a base station may configure at least one DL/UL BWP for a terminal associated with a wideband CC. A base station may activate at least one DL/UL BWP of configured DL/UL BWP(s) at a specific time (by L1 signaling or MAC control element (CE) or RRC signaling, etc.). In addition, a base station may indicate switching to another configured DL/UL BWP (by L1 signaling or MAC CE or RRC signaling, etc.). Alternatively, based on a timer, when a timer value is expired, it may be switched to a determined DL/UL BWP. Herein, an activated DL/UL BWP is defined as an active DL/UL BWP. However, a configuration on a DL/UL BWP may not be received when a terminal performs an initial access procedure or a RRC connection has not been set up yet, so a DL/UL BWP which is assumed by the terminal in such a situation is defined as an initial active DL/UL BWP.

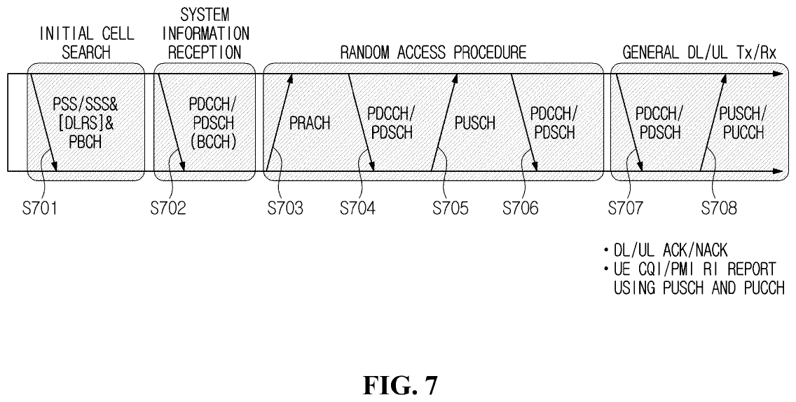

FIG. 7 exemplifies physical channels used in a wireless communication system, to which the present disclosure may be applied, and a general signal transmission and reception method using the physical channels.

In a wireless communication system, a terminal receives information from a base station through a downlink, and the terminal transmits information to the base station through an uplink. Information transmitted and received by the base station and the terminal includes data and a variety of control information, and a variety of physical channels exist according to a type/a usage of information transmitted and received by them.

When a terminal is turned on or newly enters a cell, the terminal performs an initial cell search including synchronization with a base station (S701). To this end, the terminal may synchronize with the base station by receiving a primary synchronization signal (PSS) and a secondary synchronization signal (SSS) from the base station and obtain information such as a cell identifier (ID) and the like. Next, the terminal may obtain broadcasting information in a cell by receiving a physical broadcast channel (PBCH) from the base station. Meanwhile, the terminal may check out a downlink channel state by receiving a downlink reference signal (DL RS) at the initial cell search step.

The terminal, which has completed initial cell search, may obtain more detailed system information by receiving a physical downlink control channel (PDCCH) and a physical downlink shared channel (PDSCH) according to information carried in the PDCCH (S702).

Meanwhile, in case the terminal accesses to the base station for the first time or does not have a radio resource for signal transmission, the terminal may perform a random access procedure (RACH) for the base station (S703 to S706). To this end, the terminal may transmit a specific sequence as a preamble through a physical random access channel (PRACH) (S703 and S705) and receive a response message for the preamble through a PDCCH and a corresponding PDSCH (S704 and S706). In the case of a contention-based RACH, a contention resolution procedure may be additionally performed.

The terminal, which has performed the above-described procedure, may subsequentially perform PDCCH/PDSCH reception (S707) and physical uplink shared channel (PUSCH)/physical uplink control channel (PUCCH) transmission (S708) as a general uplink/downlink signal transmission procedure. In particular, the terminal receives downlink control information (DCI) through a PDCCH. Herein, the DCI includes control information such as resource allocation information for the terminal and has a different format depending on its purpose of use.

Meanwhile, control information, which is transmitted by the terminal to the base station through an uplink or is received by the terminal from the base station, includes a downlink/uplink acknowledgement/non-acknowledgement (ACK/NACK) signal, a channel quality indicator (CQI), a precoding matrix indicator (PMI), a rank indicator (RI), and the like. For a 3GPP LTE system, the terminal may transmit control information of the above-described CQI/PMI/RI and the like through a PUSCH and/or a PUCCH.

Hereinafter, an uplink operation will be described in consideration of co-existence of various types of terminals. Specifically, a method for allocating a resource to various types of terminals by increasing a control resource at an initial access step before providing a data service will be described.

A terminal type may be determined differently according to a wireless communication system version. A terminal, which has a limited capability to reduce terminal power consumption, may be a terminal type using a 20 MHz band. For example, as for the terminal having a limited capability, the terminal type using the 20 MHz band may be a reduced capability (redcap) terminal. Alternatively, as an example, it may be a release 17 redcap type. As an example, a redcap terminal may use a 20 MHz radio frequency (RF) element and a 20 MHz baseband but may not be limited thereto.

As another example, a terminal, which has a limited capability to reduce terminal power consumption, may be a terminal type that uses a 20 MHz band but uses a 5 MHz band only for unicast. As an example, the terminal type, which uses the 20 MHz band but uses the 5 MHz band only for unicast, may be an enhanced reduced capability (e-redcap) terminal. Alternatively, as an example, it may be a release 18 redcap terminal type or a release X (X>18) redcap terminal type and is not limited to a specific embodiment.

As another example, a terminal type with a limited capability may be a terminal that uses the 20 MHz band like a redcap terminal but has a limited peak data rate (max T-put) of 10 Mbps, but is not limited to a specific form.

As another example, a terminal type with a limited capability may be a terminal using a 5 MHz band but is not limited to a specific form.

As another example, a terminal type with a limited capability may be a terminal type that uses the above-described band in a FR1 frequency band (Sub-6 GHZ) but uses a different band in a FR2 frequency band (24 GHz or greater), and the terminal type is not limited to a specific form.

As another example, as a legacy terminal type, a terminal type without a limited capability may be an existing terminal type. That is, based on what is described above, a terminal type may be configured in various forms but may not be limited to a specific form.

Hereinafter, for convenience of explanation, a legacy terminal type and a terminal type with a limited capability will be described based on a redcap type terminal and an e-redcap type terminal but are not limited thereto, and the description may also be applied to other types of terminals likewise.

A redcap terminal and an e-redcap terminal, which are terminals with a limited capability, may use a partial band of a band that is simultaneously used with a legacy terminal. As an example, a method of setting up a separate base station for the small band of the redcap terminal and the e-redcap terminal may be possible, but this method may have a limitation with respect to cost. In consideration of what is described above, the redcap terminal and the e-redcap terminal may use a partial band of a great band simultaneously with a legacy terminal.

Herein, as an example, it is possible to consider a case in which a terminal transmits uplink control information to a base station through a physical uplink control channel (PUCCH). After performing an initial access and being connected to the base station, the terminal may transmit the uplink control information to the base station through a configured PUCCH resource based on a dedicated PUCCH resource configuration. On the other hand, before the terminal performs the initial access, the terminal may use a common PUCCH resource based on a common PUCCH resource configuration. As an example, a common PUCCH resource set may be as shown in Table 5 below. Herein, a redcap terminal and an e-redcap terminal, which are terminals having a limited capability, may use a small band that is a part of a band used by a legacy terminal. As an example, the redcap terminal and the e-redcap terminal, which are terminals having a limited capability, may use the above-described PUCCH resource that the legacy terminal uses. However, the PUCCH resource may be a limited resource, and when an additional resource is needed for the redcap terminal and the e-redcap terminal, the resource needs to be increased. That is, the redcap terminal and the e-redcap terminal may use a same time/frequency resource as a PUCCH resource and operate by being allocated a resource distinguished from an existing PUCCH resource.

TABLE 5
Table 9.2.1-1: PUCCH resource sets before
dedicated PUCCH resource configuration

| | PUCCH | First | Number | PRB offset | Set of initial |
|---|---|---|---|---|---|
| Index | format | symbol | of symbols | RB_{BWP}^{offset} | CS indexes |
| 0 | 0 | 12 | 2 | 0 | {0, 3} |
| 1 | 0 | 12 | 2 | 0 | {0, 4, 8} |
| 2 | 0 | 12 | 2 | 3 | {0, 4, 8} |
| 3 | 1 | 10 | 4 | 0 | {0, 6} |
| 4 | 1 | 10 | 4 | 0 | {0, 3, 6, 9} |
| 5 | 1 | 10 | 4 | 2 | {0, 3, 6, 9} |
| 6 | 1 | 10 | 4 | 4 | {0, 3, 6, 9} |
| 7 | 1 | 4 | 10 | 0 | {0, 6} |
| 8 | 1 | 4 | 10 | 0 | {0, 3, 6, 9} |
| 9 | 1 | 4 | 10 | 2 | {0, 3, 6, 9} |
| 10 | 1 | 4 | 10 | 4 | {0, 3, 6, 9} |
| 11 | 1 | 0 | 14 | 0 | {0, 6} |
| 12 | 1 | 0 | 14 | 0 | {0, 3, 6, 9} |
| 13 | 1 | 0 | 14 | 2 | {0, 3, 6. 9} |
| 14 | 1 | 0 | 14 | 4 | {0, 3, 6, 9} |
| 15 | 1 | 0 | 14 | [symbol] | {0, 3, 6, 9} |

[symbol]

indicates data missing or illegible when filed

As an example, during an initial access process, a terminal may receive system information that is broadcast from a base station. In addition, the terminal may receive a system information block (SIB) including remaining minimum system information (RMSI). The SIB received by the terminal may include PUCCH resource set information. Herein, the PUCCH resource set information may include PUCCH allocation information for an e-redcap terminal with a limited capability based on the above-described Table 5, which will be described below. The terminal may decode and store the information before physical random access channel (PRACH) transmission.

As a more specific example, in case a terminal, which is a legacy terminal, uses an initial access or common PUCCH resource, the terminal may obtain index information based on a PUCCH resource set of Table 5. Herein, the PUCCH resource set of Table 5 may consider only a PUCCH format 0 or a PUCCH format 1. That is, for a common PUCCH resource, only the PUCCH format 0 or the PUCCH format 1 may be considered. On the other hand, in case the terminal transmits uplink control information based on a dedicated PUCCH resource, the terminal may transmit the uplink control information on a PUCCH resource that is allocated based on at least one of PUCCH formats 2, 3 and 4.

As an example, in case a terminal receives “Index 0” in Table 5, the terminal may include and transmit PUCCH information in two symbols from a 13th symbol and one physical resource block (PRB) based on the PUCCH format 0. Herein, a PRB offset may be 0, and an initial value of a cyclic shift (CS) index may be 0 or 3. That is, the terminal may perform PUCCH transmission based on a configuration corresponding to an index indicated by Table 5.

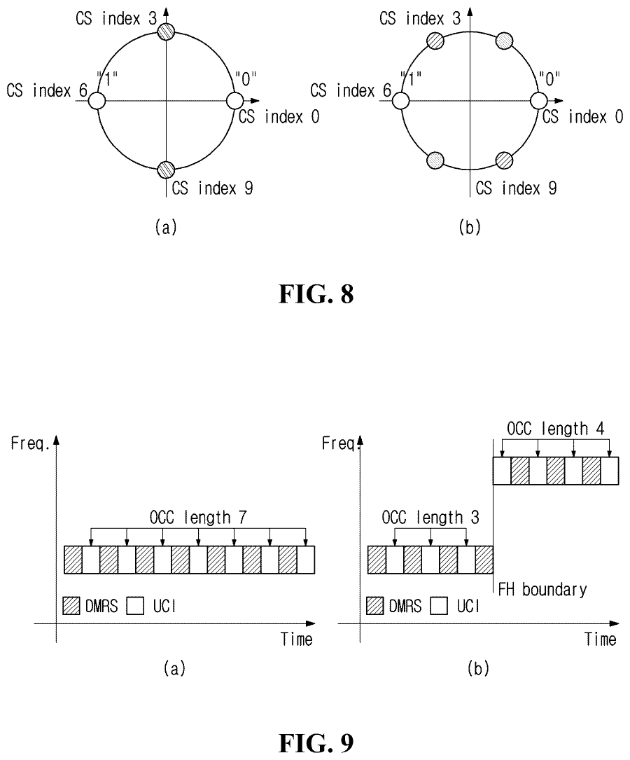

FIG. 8 is a view showing an initial start position of a CS index based on an index for a PUCCH resource set used in a wireless communication system to which the present disclosure is applicable.

As an example, in case a terminal receives the above-described “Index 0”, the terminal may perform PUCCH transmission based on the PUCCH format 0, and an initial value of a CS index may be 0 or 3. Referring to (a) of FIG. 8, each terminal may be distinguished according to a start portion of the CS index. That is, one terminal may start at a CS index “0”, and another terminal may start at a CS index “3”, so that the terminals may be distinguished from each other. In case the start position of the CS index is “0”, a value may be indicated by m_{cs}=0 and 180 degree shifted m_{cs}=6. On the other hand, for another terminal, if a start position of the CS index is “3”, a value may be indicated by m_{cs}=3 and 180 degree shifted m_{cs}=9. As a more specific example, when HACK-ACK feedback information as uplink control information is transmitted based on the PUCCH format 0, if a sequence cyclic shift is m_{cs}=0, a first value may be indicated, and if a sequence cyclic shift is m_{cs}=6, a second value may be indicated. That is, uplink control information may be distinguished and transmitted based on a sequence cyclic shift value.

Referring to (b) of FIG. 8, in case a terminal receives the above-described “Index 1” or “Index 2”, the terminal may perform PUCCH transmission based on the PUCCH format 0, and an initial value of the CS index may be 0, 4 or 8. The CS index may be distinguished based on a 180 degree shifted value, and three terminals may be distinguished in (b) of FIG. 8.

In addition, as an example, the PUCCH format 0 may include a feature for Table 6 below. The PUCCH format 0 may include small-sized uplink control information in consideration of low latency support and have a low peak-to-average power ratio (PAPR). Herein, a sequence for the PUCCH format 0 may be determined based on cyclic shift selection. When a PUCCH resource is allocated based on the PUCCH format 0, the PUCCH resource may be allocated to one physical resource block (PRB) and 1 to 2 symbols. As an example, a maximum of 3 terminals multiplexing (2 bits) or 6 terminals multiplexing (1 bit) may be considered for each PRB, which is as shown in Table 6 below.

In addition, as an example, the PUCCH format 1 may include a feature for Table 7 below. The PUCCH format 1 may include small-sized uplink control information in consideration of coverage support, and high multiplexing may be applied. When a PUCCH resource is allocated based on the PUCCH format 1, the PUCCH resource may be allocated to one PRB and 4 to 14 symbols. Herein, a maximum of 84 terminals (12CS*70CC) may be allocated in each PRB, which is as shown in Table 7 below.

TABLE 6
PUCCH format 0

Design target: low latency support, small size UCI, low PAPR
Sequence (CS) selection based structure without DMRS
Occupancy: 1 PRB, 1~2 symbols
Capacity: maximum 3 UEs (2-bit) or 6 UEs (1-bit) per PRB

TABLE 7
PUCCH format 1

Design target: coverage support, small size UCI, high multiplexing
LTE PF1-like structure (DMRS/UCI symbol alternating with T-domain
OCC)
Occupancy: 1 PRB, 4~14 symbols
Capacity: maximum 84 UEs (12 CSs × 7 OCCs) per PRB

As described above, a maximum of 3 terminals (2 bits) or 6 terminals (1 bit) may be distinguished by the PUCCH format 0. Herein, a (e-redcap) terminal using a 5 MHz band may use a part of a great band simultaneously with a legacy terminal. As an example, the terminal using the 5 MHz band may use the above-described common PUCCH resource simultaneously with a legacy terminal. Accordingly, a resource of the terminal using the 5 MHz band may have to be distinguished.

Herein, as there may be various types of (e-redcap) terminals using the 5 MHz band, there may be a shortage of CS-type PUCCH resource, and any one technique of CDM, TDM and FDM may be considered to increase the resource. That is, by further applying at least any one technique of CDM, TDM and FDM to an existing PUCCH resource, a resource may be secured to be used by a (e-redcap) terminal using a 5 MHz.

In consideration of the above description, an orthogonal cover code (OCC) may be applied to the PUCCH format 0 by the code division multiplexing (CDM) technique. Like the Walsh code, the OCC has orthogonality and consists of codes that become zero when multiplied by each other and then aggregated. As an example, in relation to the OCC, an orthogonal sequence of phase shift is used in a complex number of a Zadoff-Chu sequence form but may not be limited thereto.

As an example, the PUCCH format 0 did not use an OCC but may use an OCC for a resource of a 5 MHz redcap (e-redcap) terminal. As a specific example, for a code (1, 1) and (1, −1) with a length of 2, (1, 1) may be an index 0, and (1, −1) may be an index 1. In the case of (1, 1) with the index 0, when the OCC is applied to an OFDM symbol, a same value may be obtained. That is, when the OCC is not used, the result may be the same as when the OCC index 0 is applied. In consideration of the above description, a legacy terminal may use the OCC index 0. On the other hand, when (−1, 1) or (1, −1) is multiplied by an OFDM symbol, a different value may be obtained, and thus a PUCCH resource may be increased. That is, a legacy terminal may use a PUCCH resource of Table 5 by using the OCC index 0, and a (e-redcap) terminal using a 5 MHz band may be allocated and use a separate resource distinguished from the PUCCH resource of Table 5 by applying (−1, 1) or (1, −1). Herein, as an example, an OCC length applied to the PUCCH format 0 may be 2 but is not limited thereto.

As an example, a base station may deliver an OCC value to a terminal through higher layer signaling (e.g., RRC signaling). Specifically, the base station may receive terminal capability information from a terminal and identify a terminal type based on the terminal capability information. Herein, the base station may indicate a different OCC value depending on whether the terminal is a legacy terminal or a (e-redcap) terminal using 5 MHz band and thus may use respective resources.

As another example, an index of Table 5 may be newly configured by reflecting an OCC value. Specifically, OCC may be added as a new field to Table 5, and an index may be set by considering an OCC value. That is, a terminal may receive an index value based on a PUCCH resource set as in the existing case and apply a corresponding OCC value to the above-described index value. As another example, an OCC value may be a preset value. Specifically, a preset OCC value may be stored in an e-redcap terminal. After a terminal delivers terminal capability information to a base station, the base station may indicate an index corresponding to a common PUCCH resource to the terminal. Herein, if the terminal is an e-redcap terminal, the terminal may identify a PUCCH resource by applying a preset OCC value.

As another example, a resource may be increased by applying CDM (OCC) to the PUCCH format 1. In the case of the PUCCH format 1, a legacy terminal may apply CDM (OCC) only when a dedicated PUCCH resource is set after initial access. On the other hand, when the PUCCH format 1 is used in a common PUCCH resource before initial access, the legacy terminal may use the OCC index 0. Herein, the OCC index 0 is (1, 1), which may be the same value even after being applied to an OFDM symbol. That is, when the OCC is not used, the result may be the same as when the OCC index 0 is applied. As an example, an e-redcap terminal, which uses a partial band simultaneously with the legacy terminal, may use a PUCCH resource, and to this end, a resource may have to be increased. In consideration of what is described above, in the PUCCH format 1, a same OCC method as in a dedicated PUCCH may be applied to a common PUCCH before initial access.

As an example, Table 8 may be an OCC index applied to the PUCCH format 1 and be indicated through higher layer signaling (e.g., timeDomainOCC). Herein, OCC may be multiplied by a symbol including remaining uplink control information excluding a demodulation reference signal (DMRS) among 14 OFDM symbols within a slot. FIG. 9 is a view showing a method for applying an OCC to the PUCCH format 1 used in a wireless communication system to which the present disclosure is applicable. As an example, referring to (a) of FIG. 9, while frequency hopping (FH) is not applied, an OCC with a length of 7 may be multiplied by a symbol including uplink control information based on Table 8 below. As another example, referring to (b) of FIG. 9, based on application of FH, an OCC with a length of 3 and an OCC with a length of 4 may each be applied based on an FH boundary and be multiplied by a symbol including uplink control information.

TABLE 8

[symbol]

| | i = | i = | i = | i = | i = | i = | i = | [symbol] |
|---|---|---|---|---|---|---|---|---|
| [symbol] | 0 [symbol] | 1 [symbol] | 2 [symbol] | 3 [symbol] | 4 [symbol] | 5 [symbol] | 6 [symbol] | [symbol] |
| [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] |

[symbol]

indicates data missing or illegible when filed

An OCC may be applied to the PUCCH format 1 as a dedicated PUCCH resource, as described above, but only the OCC index 0 is applied to the PUCCH format 1 of a common PUCCH resource so that the OCC may not be used. Herein, as an example, in order to support an e-redcap terminal, the OCC may be used also in the PUCCH format 1 of the common PUCCH resource.

For what is described above, a base station may deliver an OCC value to a terminal through higher layer signaling (e.g., RRC signaling). Specifically, the base station may receive terminal capability information from the terminal and identify a terminal type based on the terminal capability information. The base station may indicate a different OCC value for the PUCCH format 1 depending on whether the terminal is a legacy terminal or an e-redcap terminal and thus may use respective resources.

As another example, Table 5 may be newly configured by reflecting an OCC value. Specifically, OCC may be added as a new field to Table 5, and an index may be set by considering an OCC value. That is, an index for the PUCCH format 1 may be added by considering OCC. A terminal may receive an index value based on a PUCCH resource set as in the existing case and apply a corresponding OCC value to the above-described index value.

As another example, an OCC value may be a preset value. Specifically, a preset OCC value may be stored in an e-redcap terminal, and the e-redcap terminal may distinguish PUCCH resources by applying the preset OCC value.

As another example, for an e-redcap terminal, a frequency position and the number of frequencies may be differently set by applying CDM (OCC) to a PUCCH resource. In the above-described Table 5, a PRB offset is an offset that is provided based on a bandwidth part (BWP), and the PRB offset may indicate an index position of a start frequency resource block (RB). Herein, based on Table 5, an index is indicated for one resource set, but the resource set may include 16 resources. As an example, the 16 resources in the resource set may be distinguished by a CS and the number of RBs. Accordingly, when the CS is 2, 8 RBs may be used. On the other hand, when the CS is 4, 4 RBs may be used. Accordingly, as the CS increases, the number of RBs may decrease, and as the CS decreases, the number of RBs may increase.

As an example, FIG. 10 is a view showing a method for allocating a PRB of a PUCCH resource used in a wireless communication system to which the present disclosure is applicable. Referring to FIG. 10, CS may be 2, and RB may be 8. Based on the above-described method, a resource may be set in a legacy terminal, a redcap terminal and an e-redcap terminal with a limited capability. As an example, when an PRB offset is 0, allocation may be performed from a PRB 0, and when the PRB offset is 4, a start RB may be a PRB 4, and thus a resource may be allocated.

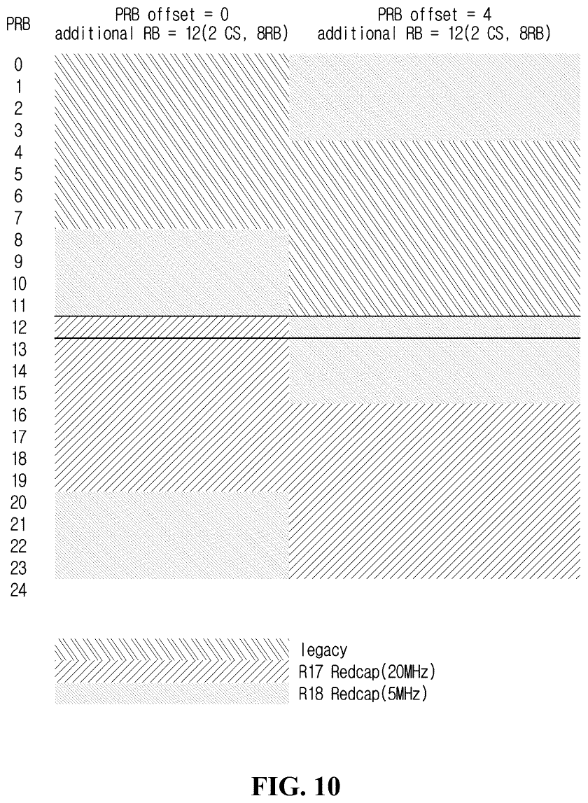

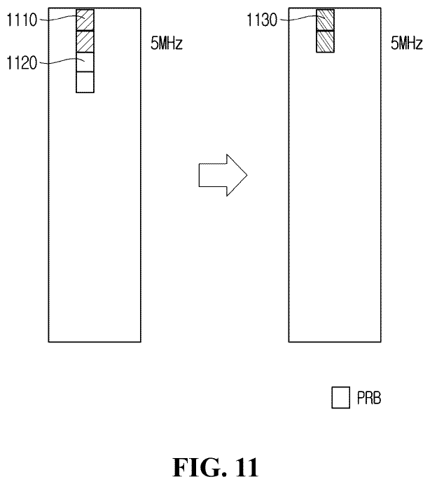

Herein, FIG. 11 is a view showing a method for allocating a PRB of a PUCCH resource used in a wireless communication system to which the present disclosure is applicable. Referring to FIG. 11, when a (e-redcap) terminal, which has a limited capability and uses a 5 MHz band, uses a great frequency band, the terminal may not be able to use much physical uplink shared channel (PUSCH) traffic. In consideration of what is described above, a method for decreasing a PRB resource may be required.

As an example, 16 resources may be distinguished in each resource set by further applying an OCC. That is, a resource set may distinguish resources by considering a CS, a PRB and an OCC. As a specific example, when the number of CSs is 2, the number of PRBs may be 8. In addition, when the number of CSs is 4, the number of PRBs may be 4. Herein, when 2 OCCs are used, the number of PRBs may be halved. As a specific example, when the number of CSs is 2 and 2 OCCs are used, the number of PRBs may be decreased from 8 to 4. Thus, in an actual frequency resource domain, a PUCCH resource domain may be reduced. Because the e-redcap terminal uses a small 5 MHz band, if a frequency domain for a control channel is increased, the use of a shared channel for transmitting traffic may be limited. In consideration of what is described above, a resource may be distinguished by applying an OCC additionally.

Referring to FIG. 11, when 2 OCCs are allocated, resources may be distinguished in a time domain and a frequency domain based on CDM, and thus terminal multiplexing may be possible. As an example, it is possible to consider a case in which 14 uplink control information symbols are used by using the PUCCH format 1 with Index 12 in Table 5. Herein, the OCC index 0 may be used for a PUCCH resource for a legacy terminal, and the OCC index 1 and the OCC index 2 may be used for an e-redcap terminal.

As an example, referring to FIG. 11, among 4 PRBs, 2 PRBs 1110 may use the OCC index 1, and the remaining 2 PRBs 1120 may use the OCC index 2. That is, a total of 4 PRBs may be used. Herein, when an OCC is used to distinguish a resource in a resource set, since a resource may be distinguished according to an OCC index in 2 PRBs 1130, only the 2 PRBs 1130 may be used. As another example, when as many as 4 OCCs are allocated, only 1 PRB may be used, and the present disclosure is not limited to a specific embodiment.

As another example, a method for setting an OCC index for an e-redcap terminal may be required. As an example, an OCC value may be preset in an e-redcap terminal. That is, the e-redcap terminal may receive an index value for a common PUCCH resource set and perform transmission by applying a preset OCC index to a corresponding PUCCH configuration.

As another example, an e-redcap terminal may receive OCC index information from a base station. The OCC index information may be indicated to the terminal through RRC signaling as higher layer signaling.

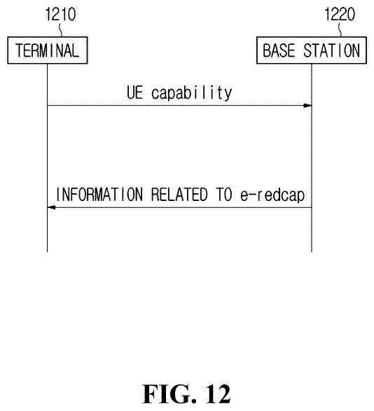

As an example, FIG. 12 is a view showing a method for indicating information for an e-redcap terminal used in a wireless communication system to which the present disclosure is applicable. Referring to FIG. 12, a terminal 1210 may deliver terminal capability (UE capability) information to a base station 1220. Herein, the terminal capability information is terminal type information and may include information indicating whether the terminal is a redcap terminal or an e-redcap terminal. That is, based on the terminal capability information, the base station 1220 may perceive whether the terminal is an e-redcap terminal. In case the terminal is an e-redcap terminal, the base station 1220 may perceive the terminal type based on the terminal capability information and indicate information for the e-redcap terminal to the terminal 1210. Herein, as an example, the information for the e-redcap terminal may be the above-described OCC value. That is, the e-redcap terminal may perceive the OCC index value based on higher layer signaling.

As another example, information for an e-redcap terminal may be at least one of a start symbol value and an offset value, which will be described in TDM technique below.

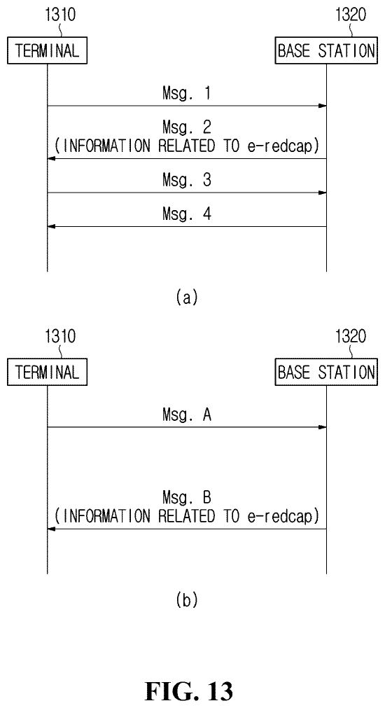

FIG. 13 is a view showing a method for indicating an OCC index used in a wireless communication system to which the present disclosure is applicable. Referring to (a) of FIG. 13 and (b) of FIG. 13, a terminal 1310 and a base station 1320 may perform initial access. As an example, referring to (a) of FIG. 13, the terminal may transmit Msg.1 including a random access preamble to the base station 1320, and the base station 1320 may transmit Msg.2 including a random access response to the terminal 1310. Next, the terminal 1310 may transmit Msg.3 for RRC connection to the base station 1320, and the base station 1320 may transmit Msg.4 to the terminal 1310 based on contention resolution. As another example, referring to (b) of FIG. 13, the terminal 1310 may transmit Msg. A corresponding to Msg.1 and Msg.3 to the base station 1320, and the base station 1320 may transmit Msg. B corresponding to Msg.2 and Msg.4 to the terminal 1310. Herein, as an example, information for an e-redcap terminal may be included in a medium access control control element (MAC CE) of RAR as Msg.2 or Msg. B and be transmitted to the terminal 1310. That is, OCC index information may be included in an MAC CE of RAR as Msg.2 or Msg. B and be transmitted to the terminal 1310.

As another example, information for an e-redcap terminal may be included in downlink control information (DCI) in Msg.2 or Msg. B and be transmitted to the terminal 1310, and the present disclosure is not limited to a specific embodiment. That is, OCC index information may be included in DCI in Msg.2 or Msg. B and be transmitted to the terminal 1310, and the present disclosure is not limited to a specific embodiment.

As another example, when there is one OCC index, a base station may indicate the OCC index to a terminal through an MAC CE of RAR or DCI of Msg.2 or Msg.B.

On the other hand, when a plurality of OCC indexes are set, the base station may indicate an OCC index to the terminal through higher layer signaling.

As another example, when there are a plurality of OCC indexes, a common PUCCH resource set index considering the plurality of OCC indexes may be set. That is, in the above-described Table 5, an OCC index field may be added, and a new index may be added based on the OCC index field, but the present disclosure may not be limited thereto. Based on what is described above, when a terminal identifies a PUCCH resource set index, the terminal may also identify a corresponding OCC index.

As another example, when a PUCCH resource is extended by applying an OCC, frequency hopping (FH) may be disabled. That is, only when FH is disabled, a PUCCH resource may be extended by applying an OCC, but the present disclosure may not be limited thereto.

As another example, the above-described resource block of FIG. 4 may include symbol information (1 bit, 2 bit, 4 bit, . . . ), and 14 symbols may be included on a time axis within a single subframe. In addition, the number of subframes on a frequency axis may be different according to a bandwidth part (BWP). Herein, referring to the above-described Table 5, a corresponding start symbol may be determined based on an index for a PUCCH resource set. The start symbol may be determined among the 14 symbols, and a PUCCH resource may be allocated from the start symbol based on the number of symbols. That is, in Table 5, a start symbol and the number of symbols may be fixed in response to each index. As an example, an e-redcap terminal may use a part of a same band simultaneously with a legacy terminal and use a common PUCCH resource. However, the PUCCH resource may have a limitation, and the PUCCH resource needs to be extended for the e-redcap terminal. Herein, the resource may be increased by setting a different start symbol corresponding to the PUCCH resource, and the e-redcap terminal may be the resource. That is, a base station may distinguish a resource used by an e-redcap terminal, which is a terminal using a 5 MHz band, on a PUCCH resource starting from another start symbol.

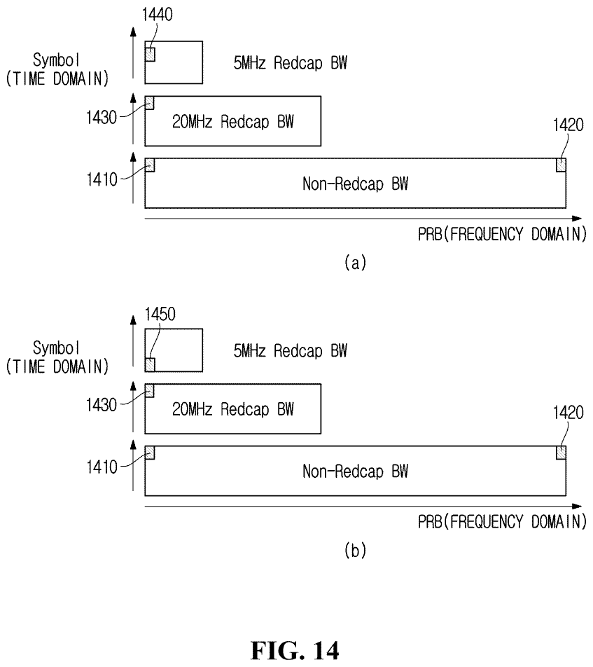

FIG. 14 is a view showing a method for determining a start symbol position differently according to a terminal type in a wireless communication system to which the present disclosure is applicable. Referring to (a) of FIG. 14, (b) of FIG. 14 and the above-described Table 5, when the PUCCH format 0 is used, a start symbol, to which a PUCCH resource is allocated, may be always a 13th symbol. As an example, PUCCH resources 1410 and 1420 used by a legacy terminal and a PUCCH resource 1430 used by a redcap terminal using a 20 MHz band may always have the 13th symbol as a fixed start symbol. Herein, a start symbol of an e-redcap terminal using the 5 MHz band may be set as another symbol. That is, resources 1440 and 1450 used by the e-redcap terminal may be shifted on a time axis as compared with a PUCCH resource used by another type of terminals. Thus, the e-redcap terminal using the 5 MHz band may allocate a resource based on a different start symbol from the start symbol of the PUCCH format 0 and perform transmission. That is, an uplink control resource may be increased based on the time division multiplexing (TDM) technique, and the increased resource may be used for the e-redcap terminal using the 5 MHz band.

As another example, a resource of an e-redcap terminal using a 5 MHz band may be set through time-axis shift based on the PUCCH format 1. However, referring to Table 5, the PUCCH format 1 consists of different indexes from the PUCCH format 0, and in comparison with the PUCCH format 0, the PUCCH format 1 may have a limited number of resources capable of being shifted on time axis. Specifically, in the PUCCH format 1, when the symbol length in Table 5 is 4, shift on time axis is possible, which may correspond to indexes 3, 4, 5 and 6. That is, when the symbol length is 10 or 14, they may not be available because of overlap with another PUCCH resource in a slot.

In consideration of what is described above, a resource of an e-redcap terminal using a 5 MHz band corresponding to the PUCCH format 1 may be set by shifting a start symbol based on the indexes 3, 4, 5 and 6. Specifically, the indexes 3, 4, 5 and 6 may have a start symbol 10. Accordingly, in the PUCCH format 1 with the symbol length of 4, a start symbol may be set to another symbol (e.g., 0, 2, 4, 6, etc.) and be allocated as a resource of the e-redcap terminal using the 5 MHz band. As an example, the above-described resource for the e-redcap terminal using the 5 MHz band may be configured as an additional index in Table 5.

As another example, a parameter for a shift value may be indicated to an e-redcap terminal using a 5 MHz band through higher layer signaling. The e-redcap terminal using the 5 MHz band may shift an OFDM symbol position based on the parameter, and a resource may be distinguished accordingly. As an example, if the parameter is not set, a start symbol may be 10. That is, the parameter for the shift value may be recognized as 0 and be used as a PUCCH format 1 resource of a legacy terminal.

As another example, a frequency position and the number of frequencies may be differently set for an e-redcap terminal by applying the above-described TDM method to a PUCCH resource. In the above-described Table 5, a PRB offset is an offset, which is provided based on a BWP, and may indicate an index position of a start frequency resource block (RB). Herein, an index is indicated for one resource set based on Table 5, but 16 resources may be included in the resource set. As an example, when a CS is 2, 8 RBs may be used. On the other hand, when a CS is 4, 4 RBs may be used. That is, a resource may be distinguished by a CS and a RB, and 16 resources may be included. Accordingly, as the CS increases, the number of RBs may decrease, and as the CS decreases, the number of RBs may increase.

As an example, referring to FIG. 10 described above, CS may be 2, and RB may be 8. Based on the above-described method, a resource may be allocated to a legacy terminal, a redcap terminal and an e-redcap terminal with a limited capability. When a PRB offset is 0, allocation may be performed from a PRB 0, and when a PRB offset is 4, a start RB may be a PRB 4, and a resource may be allocated based on this.

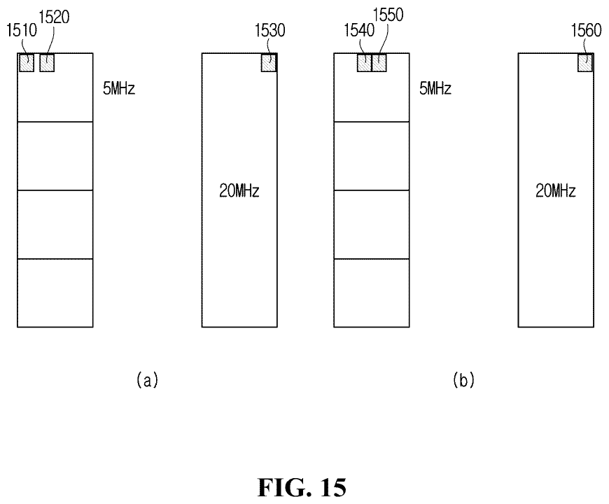

Herein, FIG. 15 is a view showing a method for allocating a PRB of a PUCCH resource used in a wireless communication system to which the present disclosure is applicable. Referring to FIG. 15, when an e-redcap terminal, which uses a 5 MHz band, uses a great frequency band, the terminal may not be able to use much physical uplink shared channel (PUSCH) traffic. In consideration of what is described above, a method for decreasing a PRB resource may be required. As an example, as described above, 16 resources may be distinguished in each resource set by further applying the TDM method. Herein, the TDM method may be a method that sets a plurality of start symbols or applies a gap symbol. That is, a resource set may distinguish resources by providing not only a CS and a PRB but also a plurality of settings by the TDM method.

As a specific example, when the number of CSs is 2, the number of PRBs may be 8, and when the number of CSs is 4, the number of PRBs is 4. Herein, when 2 starts symbols are used, resources may be distinguished according to each start symbol position. Accordingly, the number of PRBs may be halved. As a specific example, when the number of CSs is 2 and the number of start symbols is 2, the number of PRBs may be decreased from 8 to 4. Thus, a PUCCH resource domain may be reduced in an actual frequency resource domain.

In case a start symbol is allocated, a resource may be distinguished based on TDM, and terminal multiplexing may be possible. As an example, when the PUCCH format 0 with the index 0 is used in Table 5, a start symbol may be 12. Herein, the start symbol may be set to a different value (0, 2, 4, 6, 8, 10, etc.) from 12. As an example, referring to (a) of FIG. 15, additional 2 start symbols may be set for an e-redcap terminal using a 5 MHz band. When a PUCCH resource is allocated based on the PUCCH format 0, a start symbol of resources 1510 and 1520 used by the e-redcap terminal using the 5 MHz band may be different from a start symbol (that is, 12) indicated by the index 0 as a legacy terminal, and thus a different resource from a resource 1530 used by the legacy terminal may be used.

In addition, referring to (b) of FIG. 15, additional 2 start symbols may be set for an e-redcap terminal using a 5 MHz band. When a PUCCH resource is allocated based on the PUCCH format 0, a start symbol of resources 1540 and 1550 used by the e-redcap terminal using the 5 MHz band may be different from a start symbol (that is, 12) indicated by the index 0 as a legacy terminal, and thus a different resource from a resource 1560 used by the legacy terminal may be used.

As an example, when a plurality of start symbols are set for an e-redcap terminal, start symbol information may be provided through higher layer signaling. Herein, each of a plurality of start symbol values may be indicated to a terminal. As another example, an offset value for indicating a plurality of start symbols may be indicated. When the offset value is indicated, a (e-redcap) terminal using a 5 MHz band may identify a position of a start symbol by applying the offset value in the start symbol of Table 5, and thus the plurality of start symbols may be indicated. However, the present disclosure is not limited to a specific embodiment.

Herein, as an example, the TDM method may be possible only when a symbol length is equal to or shorter than 4 in the PUCCH format 0 and the PUCCH format 1, which is the same as described above. That is, 2 or more additional TDM resources may be allocated in the PUCCH format 0. On the other hand, in the PUCCH format 1, only the indexes 3, 4, 5 and 6 in Table 5 may be possible, and up to 2 TDM resources may be allocated in this case. As an example, if the TDM method is additionally applied to the above-described Table 5, PUCCH resources may be distinguished, and the number of bits may be reduced by reducing the number of indexes, but the present disclosure may not be limited thereto.

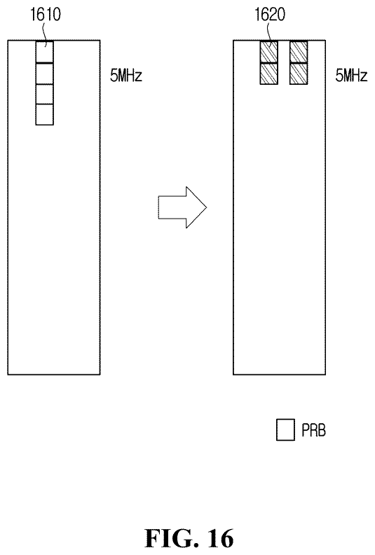

FIG. 16 is a view showing a method for allocating a PRB of a PUCCH resource used in a wireless communication system to which the present disclosure is applicable. Referring to FIG. 16, a resource in a PUCCH resource set may further be distinguished by using not only a CS and a PRB but also the above-described TDM method. Herein, because 16 resources in the PUCCH resource set are distinguished by a CS and TDM, the number of used PRBs may be reduced. As an example, when the number of CSs is 4, 4 PRBs 1610 may be needed in the PUCCH resource set. Herein, when further 2 resources in the PUCCH resource are separated by TDM, only 2 PRBs 1620 may be used. As an example, information indicated by TDM may be indicated based on higher layer signaling but is not limited thereto.

As another example, a method for indicating the TDM method to a terminal may be required. As a specific example, a base station may receive terminal capability information from the terminal and perceive that the terminal is an e-redcap terminal using a 5 MHz band. Next, the base station may transmit at least one of a start symbol and offset information for the e-redcap terminal using the 5 MHz band together with a common PUCCH resource set to the terminal. As an example, start symbol information may be indicated to the terminal through higher layer signaling, and this may be the same as described in FIG. 12. Herein, the e-redcap terminal using the 5 MHz band may replace a start symbol value in Table 5 as common PUCCH resource set information by the received start symbol value and use the received start symbol value.

As another example, offset information may also be indicated to a terminal through higher layer signaling, and this may be the same as described in FIG. 12. Herein, an e-redcap terminal using a 5 MHz band may determine a start symbol by applying an offset value to a start symbol value as common PUCCH resource set information and use the start symbol.

As another example, Table 5 as a common PUCCH resource set may be newly configured. As an example, in Table 5, a different index may be added only to a start symbol, while the other values remain the same, and thus PUCCH resources may be increased.

As another example, based on FIG. 13, an e-redcap terminal using a 5 MHz band may receive start symbol information or offset information from a base station through an MAC CE of RAR or DCI of Msg. 2 or Msg. B but is not limited to a specific embodiment.

As another example, an e-redcap terminal using a 5 MHz band may use a part of a same band simultaneously with a legacy terminal and use a common PUCCH resource as described above. As an example, a redcap terminal using a 20 MHz band may also use a PUCCH resource for the legacy terminal and use an additional PBR offset to this end. Herein, as an example, the e-redcap terminal using the 5 MHz band may also use the above-described additional PRB offset for the redcap terminal using the 20 MHz band. As another example, the e-redcap terminal using the 5 MHz band may use a separate PRB offset apart from the above-described additional PRB offset for the redcap terminal using the 20 MHz band. That is, for the e-redcap terminal using the 5 MHz band, a PUCCH resource may be distinguished and extended by the FDM method.

As a specific example, it is possible to consider a case in which the e-redcap terminal using the 5 MHz band uses the above-described additional PRB offset for the redcap terminal using the 20 MHz band. In the above-described case, maximum range values may be increased.

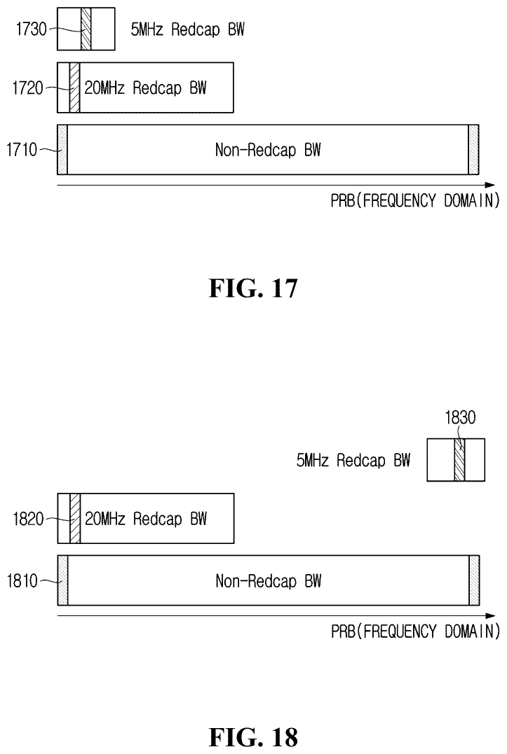

FIG. 17 is a view showing a method for allocating a PUCCH resource used in a wireless communication system to which the present disclosure is applicable. Referring to FIG. 17, only a BWP RB offset may be applied to a PUCCH resource 1710 for a legacy terminal, and this may be the same as described in Table 5. On the other hand, the above-described additional PRB offset value may be applied to a PUCCH resource 1720 for a redcap terminal using a 20 MHz band. That is, a resource of a redcap terminal using a 20 MHz band and a PUCCH resource of a legacy terminal may be distinguished through an additional PRB offset. Herein, a separate PRB offset may be set to allocate a PUCCH resource 1730 for the e-redcap terminal, and thus a resource may be distinguished. As an example, the separate PRB offset for the e-redcap terminal may be indicated based on higher layer signaling. As a specific example, the separate PRB offset for the e-redcap terminal may be set and added to a BWP offset value for a legacy terminal, and this may be the same as described in Equation 2. In Equation 2, RB_{BWP}^{offset} may be a RB offset for a legacy terminal, and RB_{BWP}^{additional,eRedCap} BWP may be a separate PRB offset for an e-redcap terminal.

$$PRB index = {RB}_{BWP}^{offset} + {RB}_{BWP}^{additional , eRedCap} + ⌊ {r}_{PUCCH} / {N}_{CS} ⌋ \qquad [ Equation 3 ]$$

As another example, a separate PRB offset for an e-redcap terminal may be added to an offset of a redcap terminal using a 20 MHz band, and this may be the same as described in Equation 4 below. Herein, the separate PRB offset for the e-redcap terminal may be a value that is additionally signaled in the offset for the redcap terminal. In Equation 4, RB_{BWP}^{offset} may be a BWP offset for a legacy terminal, RB_{BWP}^{additional} may be an offset for a redcap terminal, and RB_{BWP}^{additional,eRedCap} may be a PRB offset for an e-redcap terminal.

$$PRB index = {RB}_{BWP}^{offset} + {RB}_{BWP}^{additional} + {RB}_{BWP}^{additional , eRedCap} + ⌊ {r}_{PUCCH} / {N}_{CS} ⌋ \qquad [ Equation 4 ]$$

FIG. 18 is a view showing a method for allocating a PUCCH resource used in a wireless communication system to which the present disclosure is applicable. Referring to FIG. 18, it is possible to consider a case in which a PRB offset for an e-redcap terminal using a 5 MHz band exceeds 12. As an example, because the number of PRBs in 5 MHz bandwidth is 25, an offset equal to or greater than 12 PRBs may be a value equal to or greater than a half and go over to an opposite boundary (or edge).

Specifically, a PRB offset for an e-redcap terminal using a 5 MHz band may be set to up to a value of 12, and an edge indicator indicating a boundary may further be set. Based on the edge indicator, a terminal may identify a boundary that is a criterion and perceive a resource position for the e-redcap terminal using the 5 MHz band through a PRB offset for the e-redcap terminal using the 5 MHz band from the boundary.

As a specific example, only a BWP RB offset may be applied to a PUCCH resource 1810 for a legacy terminal, and this may be the same as described in Table 5. On the other hand, an additional PRB offset value may be applied to a PUCCH resource 1820 for a redcap terminal using a 20 MHz band. That is, a resource of a redcap terminal using a 20 MHz band and a PUCCH resource of a legacy terminal may be distinguished through an additional PRB offset. Herein, a separate PRB offset for allocating a PUCCH resource 1830 for an e-redcap terminal using a 5 MHz band and an edge indicator may be set. The e-redcap terminal using the 5 MHz band may perceive a reference position of the separate PRB offset based on the edge indicator and perceive a resource position through the separate PRB offset.

As another example, without setting an additional PRB offset for an e-redcap terminal using a 5 MHz band, a resource for the e-redcap terminal using the 5 MHz band may be indicated by modifying only a range in a PRB offset for a redcap terminal using a 20 MHz band. As an example, a resource for the redcap terminal using the 20 MHz band may be determined and indicated as one of a plurality of PRB offset values indicated based on higher layer signaling, and the redcap terminal using the 20 MHz band may perceive a resource being used based on Equation 5 and Equation 6 below. As an example, when RB_{BWP}^{additional} is configured, it may be indicated by any one value of 2, 3, 4, 6, 8, 9, 10 and 12, and when RB_{BWP}^{additional} is not configured, it may be 0.

$$PRB index = {RB}_{BWP}^{offset} + {RB}_{BWP}^{additional} + ⌊ {r}_{PUCCH} / {N}_{CS} ⌋ \qquad [ Equation 5 ]$$

$$PRB index = {N}_{BWP}^{size} - 1 - {RB}_{BWP}^{offset} - {RB}_{BWP}^{additional} - ⌊ {r}_{PUCCH} / {N}_{CS} ⌋ \qquad [ Equation 6 ]$$

Herein, in order to indicate a resource for an e-redcap terminal using a 5 MHz band, RB_{BWP}^{additional} for a redcap terminal using a 20 MHz band may be used. However, a RB_{BWP}^{additional} range may be increased to 2, 3, 4, 6, 8, 9, 10, 12, 13, 14, etc. In addition, when RB_{BWP}^{additional} is not configured, a PRB offset may be set to a specific value of X. Specifically, when the e-redcap terminal using the 5 MHz band is also considered, there may be a shortage of PUCCH resource. Herein, if the RB_{BWP}^{additional} range is increased, an allocated resource may be increased. That is, although a same PRB offset parameter is used, the range may be additionally increased from a default of 0 to 12 PRB, and thus the resource for the e-redcap terminal using the 5 MHz band may be indicated. That is, the above-described values may be added in a parameter indicated based on higher layer signaling, and thus signaling overhead in a RRC message may not be increased.

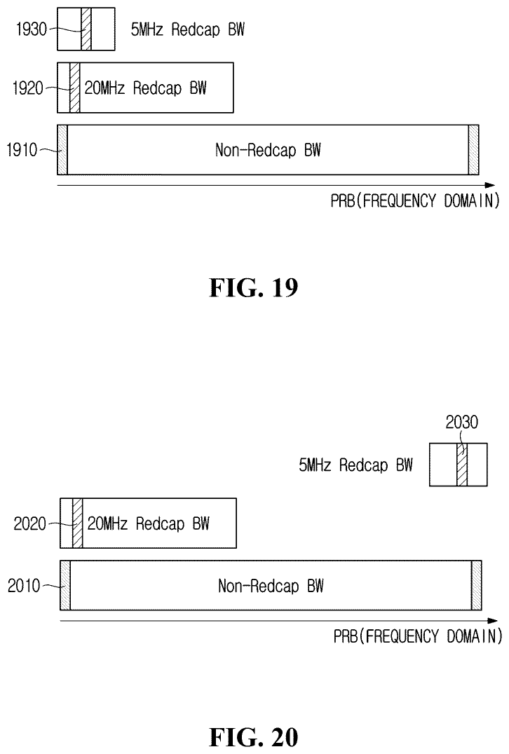

FIG. 19 and FIG. 20 are views showing a method for allocating a PUCCH resource used in a wireless communication system to which the present disclosure is applicable. As a specific example, only a BWP RB offset may be applied to a PUCCH resource 1910 for a legacy terminal, and this may be the same as described in Table 5. On the other hand, an additional PRB offset value may be applied to a PUCCH resource 1920 for a redcap terminal using a 20 MHz band. That is, a resource of a redcap terminal using a 20 MHz band and a PUCCH resource of a legacy terminal may be distinguished through a PRB offset. Herein, the above-described PRB offset value may also be applied to an e-redcap terminal using a 5 MHz band, and only a range may be different. That is, when a base station allocates a PUCCH resource to the e-redcap terminal using the 5 MHz band, the base station may use the additional PRB offset for the redcap terminal using the 20 MHz band. As another example. referring to FIG. 20, because 25 PRBs are used in the 5 MHz band, when 12 PRBs are exceeded, a PRB offset may be indicated based on an opposite boundary. That is, a PUCCH resource 2030 may be indicated to the e-redcap terminal using the 5 MHz band through the additional offset value for the redcap terminal using the 20 MHz band and an edge indicator, but the present disclosure is not limited to a specific embodiment.

As another example, a PUSCH resource may be used only on the right of a PUCCH resource. In consideration of what is described above, there may be a limitation of frequency resource availability. Accordingly, an offset for indicating a PUCCH resource of an e-redcap terminal using a 5 MHz band may be determined as an total band offset. That is, a new offset for the e-redcap terminal using the 5 MHz band may be added as the total band offset. Based on what is described above, a BWP offset of a legacy terminal and an additional PRB offset of a redcap terminal using a 20 MHz band need to be considered without failure, and a PUCCH resource may be perceived through a new total band parameter. As an example, the above-described method may be applied not only to a common PUCCH but also to a dedicated PUCCH after RRC connection, but the present disclosure is not limited to a specific embodiment.

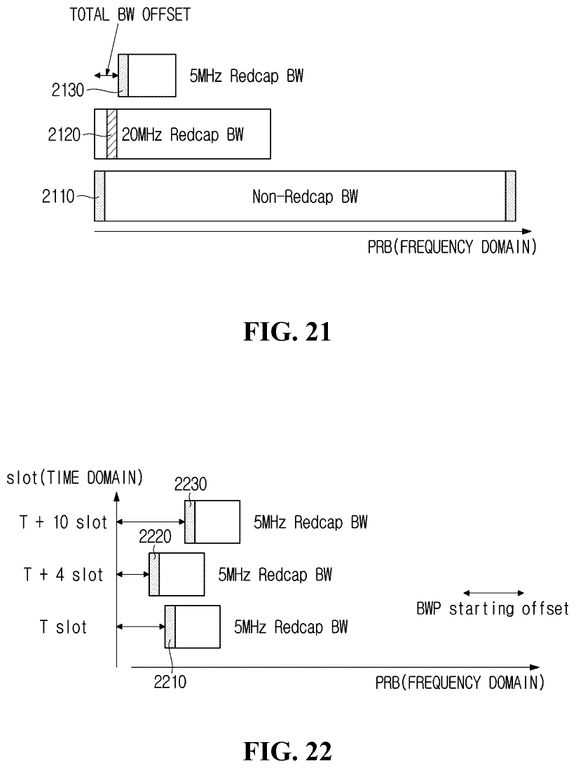

FIG. 21 is a view showing a method for allocating a PUCCH resource used in a wireless communication system to which the present disclosure is applicable. Referring to FIG. 21, a PUCCH resource for a legacy terminal may be indicated based on a BWP offset, and a PUCCH resource 2120 for a redcap terminal using a 20 MHz band may be indicated through an additional PRB offset, which is the same as described above. Herein, a PUCCH resource 2130 for an e-redcap terminal using a 5 MHz band may be indicated by a separate total band offset. That is, a separate total band offset parameter for the e-redcap terminal using the 5 MHz may be added. Thus, real-time scheduling may be possible for the e-redcap terminal using the 5 MHz. As an example, an total band offset may be indicated semi-statically by an MAC CE or dynamically by DCI (PDCCH) in consideration of real-time scheduling.

As another example, an total band offset may be applied to PUSCH and PUSCH/PUCCH transmission and be considered for downlink transmission. In addition, as an example, every time an total band offset is applied, a PRB start position with the offset being added thereto may be considered a new BWP start position. As an example, when the total band offset is 0, it may be the same as a start PRB position of a preset BWP. In addition, if the total band offset is not configured, it may be determined as 0. As an example, when an total band offset is indicated by DCI or an MAC CE, the total band offset may be differently indicated according to a slot time. FIG. 22 is a view showing a method for allocating a PUCCH resource used in a wireless communication system to which the present disclosure is applicable. Referring to FIG. 22, an total band offset value at a slot T, an total band offset value at a slot T+4, and an total band offset value at a slot T+10 may be different, and PUCCH resources 2210, 2220 and 2230 may be determined based on the respective total band offset values.

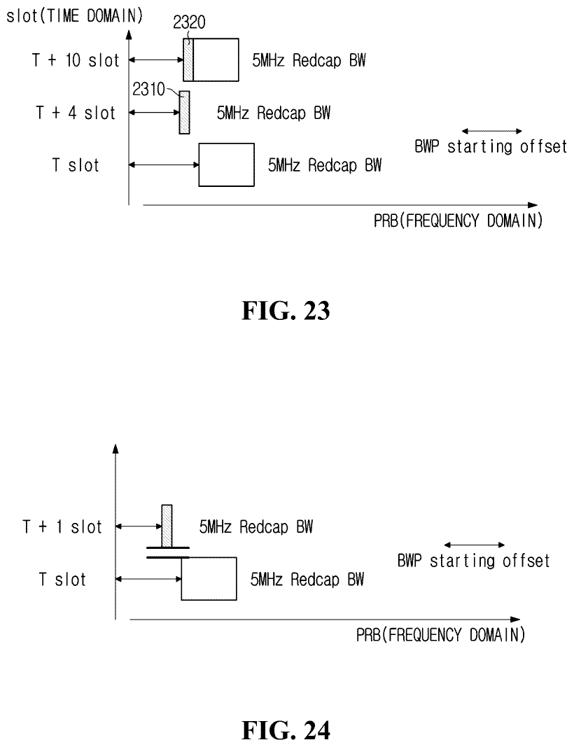

As another example, a set for offset may be set in a preconfigured RRC beforehand, and candidate values in the set may be applied according to situations. FIG. 23 is a view showing a method for allocating a PUCCH resource used in a wireless communication system to which the present disclosure is applicable. Referring to FIG. 23, it is possible to consider a case in which only a PUSCH is transmitted, a case in which only a PUCCH is transmitted, and a case in which PUSCH/PUCCH is transmitted. Herein, when only the PUCCH is transmitted, a first total band offset may be used, and when PUSCH/PUCCH transmission is performed, a second total band offset may be used, so that respective PUCCH resources 2310 and 2320 may be determined accordingly. That is, among candidate total band offsets in a preconfigured RRC set, an total band offset corresponding to a specific situation may be applied. As an example, no total band offset is applied to PRACH transmission, and an SRS may follow an offset for a PUCCH or PUSCH that is transmitted simultaneously.

As another example, when only a 5 MHz or smaller band is supported, a PUCCH PRB may be used up to 8 RBs. As an example, if a PRB domain is used as a common PUCCH domain, there may be a shortage of resource for PUSCH transmission. Herein, when up to 5 MHz band resources are all used for the PUSCH transmission, an offset may be differently applied. FIG. 24 is a view showing a method for allocating a PUCCH resource used in a wireless communication system to which the present disclosure is applicable. Herein, as an example, while an offset is differently applied, a gap OFDM symbol may be needed to apply a modified offset. As a specific example, because a base station is incapable of perceiving terminal capability during an initial access process, an offset value may be needed. However, after the base station perceives the terminal capability, the gap OFDM symbol may not be needed, but the present disclosure is not limited to a specific embodiment. As an example, a gap OFDM symbol may be as shown in Equation 7 below. Herein, the gap OFDM symbol may be fixed to a specific irrespective of terminal capability in an initial access process. On the other hand, after a base station perceives terminal capability, a different value may be set based on the terminal capability.

$$0 \leq Gap OFDM symbol \leq N \qquad [ Equation 7 ]$$

In addition, as an example, a gap OFDM symbol may be indicated by higher layer signaling. As an example, when a gap OFDM symbol is not indicated by higher layer signaling, a default value may be set to 0, but the present disclosure is not limited thereto.

As another example, an e-redcap terminal using a 5 MHz band may not consider an existing BWP. As an example, the e-redcap terminal using the 5 MHz band may be fixed only to a 5 MHz BW. In addition, the e-redcap terminal using the 5 MHz band may not consider dynamic switching by DCI based on a plurality of BWP settings. That is, only one BWP may be considered, and thus the terminal may be implemented at low cost, while performance degradation needs to be considered to some extent. As another example, unlike the existing BWP, a new BWP for 5 MHz may be considered. Herein, a maximum BW may be 5 MHz, and a new BW band may be used based on BW switching. As an example, instead of up to 4 BWs in the existing case, BW may be configured by 1≤N<4 or only one BW may be configured, but the present disclosure is not limited to a specific embodiment.

As another example, a BW offset may give an actual PRB value or configure a set by RRC parameters for some values and then indicate an index value by DCI or an MAC CE. In addition, a gap OFDM symbol may also configure a set by RRC parameters and then indicate an index value by DCI or an MAC CE, but the present disclosure is not limited to a specific embodiment. Herein, when there is no corresponding value, a value of 0 may be set as a default configuration.

As another example, in the PUCCH format 0, a new PUCCH resource set index ID using 4 CSs may be considered. Thus, the number of PRB resources of a PUCCH resource may be decreased. In addition, in the PUCCH format 1, only an index resource with the number of CSs being 4 may be used. Based on what is described above, the number of PRB resources of a PUCCH resource may be decreased. Based on the above-described method, as the number of indexes is decreased, the number of signaling bits related to the Table 5 setting of SIB1 (RMSI) may be decreased. That is, based on what is described above, a new table, which is not Table 6, may be configured.

As another example, an e-redcap terminal using a 5 MHz band may set whether frequency hopping is used (Disable/Enable) by higher layer signaling and indicate it by DCI or an MAC CE. As an example, when there is no setting, Disable may be set as a default configuration. As an example, an existing common PUCCH may perform a frequency hopping operation and be disabled at a non-licensed band. On the other hand, the e-redcap terminal using the 5 MHz band may set whether frequency hopping is used (Disable/Enable) by higher layer signaling and selectively operate.

As another example, because the e-redcap terminal using the 5 MHz band uses a small band, the e-redcap terminal may be configured not to use frequency hopping for efficient scheduling of a PUCSH when a common PUCCH is used, but the present disclosure is not limited to a specific embodiment.

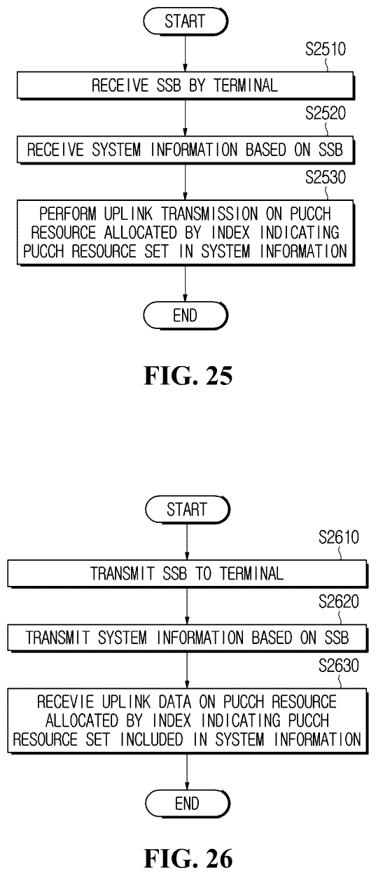

FIG. 25 a flowchart showing a method of operating a terminal that is applicable to the present disclosure.

Referring to FIG. 25, the terminal may receive a synchronization signal block (SSB) (S2510). A physical broadcast channel (PBCH) in the SSB may include a master information block (MIB). The terminal may confirm information included in the MIB in the SSB. Next, the terminal may receive system information (e.g., SIB1) from a base station based on the information included in the MIB (S2520). The system information may include an index indicating a PUCCH resource set. The terminal may perform uplink transmission on a PUCCH resource that is allocated by the index indicating the PUCCH resource set (S2530). Herein, according to a terminal type, the PUCCH resource may be used in a different form. As an example, if the terminal is a first type terminal, uplink control information may be transmitted from the terminal to the base station on a PUCCH resource that is configured by the PUCCH resource set based on the index. Herein, the first type terminal may be the above-described legacy terminal. That is, the legacy terminal may transmit the uplink control information to the base station by the PUCCH resource. On the other hand, the second type terminal may be a terminal using a 5 MHz band, and this may be the above-described e-redcap terminal. As another example, the second type terminal may be a terminal type with a limited capability and be a terminal that uses a 20 MHz band like a recap terminal but has a limited peak data rate (max T-put) of 10 Mbps. As another example, the second type terminal may be a terminal type with a limited capability and be a terminal that uses a 5 MHz band. As another example, the second type terminal may be a terminal type with a limited capability based on a wireless communication system version and be another form of terminal but is not limited to a specific form. That is, the first type terminal may be a legacy terminal operating based on a legacy system, the second type terminal may be a terminal with a different form from the legacy terminal, and the second type terminal may have a different form based on a wireless communication system version but may not be limited to a specific form.

Herein, the second type terminal may perform the uplink transmission a resource that is distinguished by applying at least one of code division multiplexing (CDM), time division multiplexing (TDM) and frequency division multiplexing (FDM) to the PUCCH resource that is configured by the PUCCH resource set based on the index, and this is the same as described above. Herein, the second type terminal may perform the uplink transmission by using a partial band of a frequency band that the first type terminal uses. That is, a legacy terminal and an e-redcap terminal may use a same band simultaneously. In addition, as an example, the terminal may use a PUCCH resource allocated by an index as a common PUCCH resource before receiving a dedicated PUCCH configuration based on a connection to the base station. Herein, at least one of a PUCCH format, a start symbol of the PUCCH resource, the number of symbols of the PUCCH resource, a physical resource block (PRB) offset of the PUCCH resource, and a set of initial cyclic shift indexes may be configured based on a PUCCH resource set, and this may be the same as described in Table 5.

Herein, if CDM being applied to the PUCCH resource, an orthogonal cover code (OCC) may be applied to a resource, through which the second type terminal performs the uplink transmission, and thus the resource may be distinguished from a PUCCH resource for the first type terminal. As an example, if a first type PUCCH format is applied to a resource for performing uplink transmission based on an index, an OCC with a length of 2 may be applied to the resource for performing the uplink transmission. Herein, the first type PUCCH format may be a PUCCH format 0.

In addition, as an example, if a second type PUCCH format is applied to the PUCCH resource based on an index, an OCC of the second type PUCCH format set by a dedicated PUCCH configuration may be applied to a resource for performing uplink transmission for the second type terminal. Herein, the second type PUCCH format may be a PUCCH format 1. In addition, a PUCCH resource set may include 16 resources, 16 resources for the first type terminal may be determined based on the number of cyclic shifts and the number of PRBs, and 16 resources for the second type terminal may be determined based on the number of cyclic shifts, the number of OCCs, and the number of PRBs.

In addition, an OCC index indicating an OCC applied to the second type terminal may be preset in the second type terminal or be indicated by the base station. Herein, when being indicated by the base station, the OCC index may be indicated to the second type terminal through higher layer signaling or be indicated in a random access procedure, and this is the same as described above.

As another example, if TDM is applied to the PUCCH resource, a start symbol of a resource for performing the uplink transmission for the second type terminal may be configured to be different from a start symbol of a PUCCH resource for the first type terminal. Thus, the resource for performing the uplink transmission for the second type terminal and the PUCCH resource for the first type terminal may be distinguished.

In addition, as an example, the base station may indicate at least one of a start symbol indication value and an offset value to the terminal, and when the terminal receives the start symbol indication value, the terminal may replace a start symbol of a PUCCH resource indicated by an index by the start symbol indication value. On the other hand, when the terminal receives the offset value, the terminal may determine a symbol obtained by applying the offset value to the start symbol of the PUCCH resource indicated by the index as a start symbol of the PUCCH resource. Herein, at least one of the start symbol indication value and the offset value that are applied to the second type terminal may be preset in the second type terminal or be indicated by the base station. As an example, when being indicated by the base station, at least one of the start symbol indication value and the offset value may be indicated to the second type terminal through higher layer signaling and be indicated in a random access procedure, and this is the same as described above. In addition, a PUCCH resource set may include 16 resources, 16 resources for the first type terminal may be determined based on the number of cyclic shifts and the number of PRBs, and 16 resources for the second type terminal may be determined based on the number of cyclic shifts, the number of start symbols, and the number of PRBs.

As another example, if FDM is applied to the PUCCH resource, an additional PRB offset other than a PRB offset may be applied to a resource for performing uplink transmission for the second type terminal. Thus, the resource for performing the uplink transmission for the second type terminal and the PUCCH resource for the first type terminal may be distinguished. Herein, the base station may indicate at least one of the additional PRB offset value and an edge indicator to the terminal.

As an example, when the terminal receives only the PRB offset value, the terminal may apply the PRB offset value to a PRB offset of a PUCCH resource indicated by an index. On the other hand, when the terminal receives the PRB offset value and the edge indicator, the terminal may apply an offset value to the PRB offset of the PUCCH resource indicated by the index based on a boundary indicated by the edge indicator, and this is the same as described above.

FIG. 26 is a flowchart showing a method of operating a base station that is applicable to the present disclosure.

Referring to FIG. 26, the base station may transmit an SSB to a terminal (S2610). A PBCH in the SSB may include an MIB. The terminal may confirm information included in the MIB. Next, the base station may transmit system information (e.g., SIB1) to the terminal based on the SSB (S2620). Herein, the system information may include an index indicating a PUCCH resource set. The terminal may perform uplink transmission on a PUCCH resource that is allocated by an index indicating the PUCCH resource set. That is, the terminal may receive uplink data through the PUCCH resource (S2630).

Herein, according to a terminal type, the PUCCH resource may be used in a different form. As an example, if the terminal is a first type terminal, uplink control information may be transmitted from the terminal to the base station on a PUCCH resource that is configured by the PUCCH resource set based on the index. Herein, the first type terminal may be the above-described legacy terminal. That is, the legacy terminal may transmit the uplink control information to the base station by the PUCCH resource. On the other hand, the second type terminal may be a terminal using a 5 MHz band, and this may be the above-described e-redcap terminal. Herein, the second type terminal may perform the uplink transmission on a resource that is distinguished by applying at least one of CDM, TDM and FDM to the PUCCH resource that is configured by the PUCCH resource set based on the index, and this is the same as described above. Herein, the second type terminal may perform the uplink transmission by using a partial band of a frequency band that the first type terminal uses. That is, a legacy terminal and an e-redcap terminal may use a same band simultaneously. In addition, as an example, the terminal may use a PUCCH resource allocated by an index as a common PUCCH resource before receiving a dedicated PUCCH configuration based on a connection to the base station. Herein, at least one of a PUCCH format, a start symbol of the PUCCH resource, the number of symbols of the PUCCH resource, a physical resource block (PRB) offset of the PUCCH resource, and a set of initial cyclic shift indexes may be configured based on a PUCCH resource set, and this may be the same as described in Table 5.

Herein, if CDM being applied to the PUCCH resource, an orthogonal cover code (OCC) may be applied to a resource, through which the second type terminal performs the uplink transmission, and thus the resource may be distinguished from a PUCCH resource for the first type terminal. As an example, if a first type PUCCH format is applied to a resource for performing uplink transmission based on an index, an OCC with a length of 2 may be applied to the resource for performing the uplink transmission. Herein, the first type PUCCH format may be a PUCCH format 0.

In addition, as an example, if a second type PUCCH format is applied to the PUCCH resource based on an index, an OCC of the second type PUCCH format set by a dedicated PUCCH configuration may be applied to a resource for performing uplink transmission for the second type terminal. Herein, the second type PUCCH format may be a PUCCH format 1. In addition, a PUCCH resource set may include 16 resources, 16 resources for the first type terminal may be determined based on the number of cyclic shifts and the number of PRBs, and 16 resources for the second type terminal may be determined based on the number of cyclic shifts, the number of OCCs, and the number of PRBs.

In addition, an OCC index indicating an OCC applied to the second type terminal may be preset in the second type terminal or be indicated by the base station. Herein, when being indicated by the base station, the OCC index may be indicated to the second type terminal through higher layer signaling or be indicated in a random access procedure, and this is the same as described above.

As another example, if TDM is applied to the PUCCH resource, a start symbol of a resource for performing the uplink transmission for the second type terminal may be configured to be different from a start symbol of a PUCCH resource for the first type terminal. Thus, the resource for performing the uplink transmission for the second type terminal and the PUCCH resource for the first type terminal may be distinguished.

In addition, as an example, the base station may indicate at least one of a start symbol indication value and an offset value to the terminal, and when the terminal receives the start symbol indication value, the terminal may replace a start symbol of a PUCCH resource indicated by an index by the start symbol indication value. On the other hand, when the terminal receives the offset value, the terminal may determine a symbol obtained by applying the offset value to the start symbol of the PUCCH resource indicated by the index as a start symbol of the PUCCH resource. Herein, at least one of the start symbol indication value and the offset value that are applied to the second type terminal may be preset in the second type terminal or be indicated by the base station. As an example, when being indicated by the base station, at least one of the start symbol indication value and the offset value may be indicated to the second type terminal through higher layer signaling and be indicated in a random access procedure, and this is the same as described above. In addition, a PUCCH resource set may include 16 resources, 16 resources for the first type terminal may be determined based on the number of cyclic shifts and the number of PRBs, and 16 resources for the second type terminal may be determined based on the number of cyclic shifts, the number of start symbols, and the number of PRBs.

As another example, if FDM is applied to the PUCCH resource, an additional PRB offset other than a PRB offset may be applied to a resource for performing uplink transmission for the second type terminal. Thus, the resource for performing the uplink transmission for the second type terminal and the PUCCH resource for the first type terminal may be distinguished. Herein, the base station may indicate at least one of the additional PRB offset value and an edge indicator to the terminal.

As an example, when the terminal receives only the PRB offset value, the terminal may apply the PRB offset value to a PRB offset of a PUCCH resource indicated by an index. On the other hand, when the terminal receives the PRB offset value and the edge indicator, the terminal may apply an offset value to the PRB offset of the PUCCH resource indicated by the index based on a boundary indicated by the edge indicator, and this is the same as described above.

Examples of the above-described proposed methods may be included as one of the implementation methods of the present disclosure and thus may be regarded as kinds of proposed methods. In addition, the above-described proposed methods may be independently implemented or some of the proposed methods may be combined (or merged). The rule may be defined such that the base station informs the UE of information on whether to apply the proposed methods (or information on the rules of the proposed methods) through a predefined signal (e.g., a physical layer signal or a higher layer signal).

Those skilled in the art will appreciate that the present disclosure may be carried out in other specific ways than those set forth herein without departing from the spirit and essential characteristics of the present disclosure. The above exemplary embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein. Moreover, it will be apparent that some claims referring to specific claims may be combined with another claims referring to the other claims other than the specific claims to constitute the embodiment or add new claims by means of amendment after the application is filed.

Examples of the above-described proposed methods may be included as one of the implementation methods of the present disclosure and thus may be regarded as kinds of proposed methods. In addition, the above-described proposed methods may be independently implemented or some of the proposed methods may be combined (or merged). The rule may be defined such that the base station informs the UE of information on whether to apply the proposed methods (or information on the rules of the proposed methods) through a predefined signal (e.g., a physical layer signal or a higher layer signal).

Those skilled in the art will appreciate that the present disclosure may be carried out in other specific ways than those set forth herein without departing from the spirit and essential characteristics of the present disclosure. The above exemplary embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein. Moreover, it will be apparent that some claims referring to specific claims may be combined with another claims referring to the other claims other than the specific claims to constitute the embodiment or add new claims by means of amendment after the application is filed.

The embodiments of the present disclosure are applicable to various radio access systems. Examples of the various radio access systems include a 3rd generation partnership project (3GPP) or 3GPP2 system.

The embodiments of the present disclosure are applicable not only to the various radio access systems but also to all technical fields, to which the various radio access systems are applied. Further, the proposed methods are applicable to mmWave and THzWave communication systems using ultrahigh frequency bands.

Additionally, the embodiments of the present disclosure are applicable to various applications such as autonomous vehicles, drones and the like.

1. A method comprising:
receiving, by a terminal, a synchronization signal block (SSB);
receiving system information based on the SSB from a base station; and
performing uplink transmission on a physical uplink control channel (PUCCH) resource allocated by an index indicating a common PUCCH resource set included in the system information,
wherein, based on the terminal being a first type terminal, uplink control information is transmitted from the terminal to the base station on a PUCCH resource that is configured by the PUCCH resource set based on the index, and
wherein, based on the terminal being a second type terminal, the uplink transmission is performed on a resource that is distinguished by applying at least one of code division multiplexing (CDM), time division multiplexing (TDM) and frequency division multiplexing (FDM) to the PUCCH resource that is configured by the PUCCH resource set based on the index.

2. The method of claim 1, wherein the first type terminal is a legacy terminal and is a terminal type that transmits the uplink control information through the PUCCH resource, and
wherein the second type terminal is a terminal using a 5 MHz band and is a terminal type that performs the uplink transmission on the PUCCH resource.

3. The method of claim 1, wherein the second type terminal performs the uplink transmission by using a partial band of a frequency band that the first type terminal uses.

4. The method of claim 1, wherein the terminal uses the PUCCH resource allocated through the index as a common PUCCH resource before receiving a dedicated PUCCH configuration based on a connection to the base station.

5. The method of claim 4, wherein at least one of a PUCCH format, a start symbol of the PUCCH resource, a number of symbols of the PUCCH resource, a physical resource block (PRB) offset of the PUCCH resource, and a set of initial cyclic shift indexes is configured based on the PUCCH resource set.

6. The method of claim 5, wherein, based on the CDM being applied to the PUCCH resource, an orthogonal cover code (OCC) is applied to a resource, through which the second type terminal performs the uplink transmission, and thus the resource is distinguished from the PUCCH resource for the first type terminal.

7. The method of claim 6, wherein, based on a first type PUCCH format being applied to the resource for performing the uplink transmission based on the index, an OCC with a length of 2 is applied to the resource for performing the uplink transmission.

8. The method of claim 6, wherein, based on a second type PUCCH format being applied to the PUCCH resource based on the index, an OCC of the second type PUCCH format set by the dedicated PUCCH configuration is applied to the resource for performing the uplink transmission for the second type terminal.

9. The method of claim 6, wherein the PUCCH resource set includes 16 resources,
wherein the 16 resources for the first type terminal are determined based on a number of cyclic shifts and a number of PRBs, and
wherein the 16 resources for the second type terminal are determined based on the number of the cyclic shifts, a number of OCCs, and the number of the PRBs.

10. The method of claim 6, wherein an OCC index indicating the OCC applied to the second type terminal is preset in the second type terminal or is indicated by the base station, and
wherein, based on being indicated by the base station, the OCC index is indicated to the second type terminal through higher layer signaling or is indicated in a random access procedure.

11. The method of claim 5, wherein, based on the TDM being applied to the PUCCH resource, a start symbol of the resource for performing the uplink transmission for the second type terminal is configured to be different from a start symbol of the PUCCH resource for the first type terminal so that the resource for performing the uplink transmission for the second type terminal and the PUCCH resource for the first type terminal are distinguished.

12. The method of claim 11, wherein the base station indicates at least one of a start symbol indication value and an offset value to the terminal,
wherein, based on the terminal receiving the start symbol indication value, the terminal replaces the start symbol of the PUCCH resource indicated by the index by the start symbol indication value, and
wherein, based on the terminal receiving the offset value, the terminal determines a symbol obtained by applying the offset value to the start symbol of the PUCCH resource indicated by the index as the start symbol of the PUCCH resource.

13. The method of claim 12, wherein at least one of the start symbol indication value and the offset value, which are applied to the second type terminal, is preset in the second type terminal or is indicated by the base station, and
wherein, based on being indicated by the base station, at least one of the start symbol indication value and the offset value is indicated to the second type terminal through higher layer signaling or is indicated in a random access procedure.

14. The method of claim 11, wherein the PUCCH resource set includes 16 resources,
wherein the 16 resources for the first type terminal are determined based on a number of cyclic shifts and a number of PRBs, and
wherein the 16 resources for the second type terminal are determined based on the number of cyclic shifts, a number of start symbols, and the number of PRBs.

15. The method of claim 5, wherein, based on the FDM being applied to the PUCCH resource, an additional PRB offset other than the PRB offset is applied to the resource for performing the uplink transmission for the second type terminal so that the resource for performing the uplink transmission for the second type terminal and the PUCCH resource for the first type terminal are distinguished.

16. The method of claim 15, wherein the base station indicates at least one of the additional PRB offset value and an edge indicator to the terminal,
wherein, based on the terminal receiving only the PRB offset value, the terminal applies the PRB offset value to a PRB offset of the PUCCH resource indicated by the index, and
wherein, based on the terminal receiving the PRB offset value and the edge indicator, the terminal applies the offset value to the PRB offset of the PUCCH resource indicated by the index based on a boundary indicated by the edge indicator.

17. A method comprising:
transmitting a synchronization signal block (SSB) to a terminal;
transmitting system information based on the SSB to the terminal; and
receiving uplink data by a physical uplink control channel (PUCCH) resource allocated by an index indicating a common PUCCH resource set included in the system information,
wherein, based on the terminal being a first type terminal, uplink control information is transmitted from the terminal to a base station on a PUCCH resource that is configured by the PUCCH resource set based on the index, and
wherein, based on the terminal being a second type terminal, the uplink transmission is performed on a resource that is distinguished by applying at least one of code division multiplexing (CDM), time division multiplexing (TDM) and frequency division multiplexing (FDM) to the PUCCH resource that is configured by the PUCCH resource set based on the index.

18. An apparatus comprising:
a transceiver; and
a processor coupled with the transceiver,
wherein the processor controls the transceiver to:
receive a synchronization signal block (SSB),
receive system information based on the SSB from a base station, and
perform uplink transmission on a physical uplink control channel (PUCCH) resource allocated by an index indicating a common PUCCH resource set included in the system information,
wherein, based on the apparatus being a first type terminal, uplink control information is transmitted from the terminal to the base station on a PUCCH resource that is configured by the PUCCH resource set based on the index, and
wherein, based on the terminal being a second type terminal, the uplink transmission is performed on a resource that is distinguished by applying at least one of code division multiplexing (CDM), time division multiplexing (TDM) and frequency division multiplexing (FDM) to the PUCCH resource that is configured by the PUCCH resource set based on the index.

19-21. (canceled)

22. The apparatus of claim 18, wherein the first type terminal is a legacy terminal and is a terminal type that transmits the uplink control information through the PUCCH resource, and
wherein the second type terminal is a terminal using a 5 MHz band and is a terminal type that performs the uplink transmission on the PUCCH resource.

23. The apparatus of claim 18, wherein the second type terminal performs the uplink transmission by using a partial band of a frequency band that the first type terminal uses.
